(19) United States
(12) Patent Application Publication
(10) Pub. No.: US 2023/0379982 A1
(43) Pub. Date: Nov. 23, 2023

(54) METHOD FOR EFFICIENTLY TRANSMITTING SIDELINK CSI REPORT FOR BEAM MANAGEMENT IN MMWAVE V2X COMMUNICATION SYSTEM

(71) Applicant: LG ELECTRONICS INC., Seoul (KR)

(72) Inventor: Bongjun HWANG, Seoul (KR)

(21) Appl. No.: 18/031,400

(22) PCT Filed: Oct. 20, 2021
(86) PCT No.: PCT/KR2021/014681

§ 371 Date: Apr. 12, 2023

(30) Foreign Application Priority Data
Oct. 20, 2020 (KR) 10-2020-0136128
Oct. 20, 2020 (KR) 10-2020-0136148

(51) Int. Cl. H04W 76/10; H04W 76/20; H04B 7/06

(52) U.S. Cl. CPC H04W 76/10; H04W 76/20; H04B 7/0626

(57) ABSTRACT

Provided are a method for efficiently transmitting a sidelink (SL) Channel State Information (CSI) report for beam management and a device therefor in an mmWave Vehicle-To-Everything (V2X) communication system. In the wireless communication system, a reception User Equipment (UE) receives, from a transmission UE, first SL control information including a first CSI-RS Resource Index (CRI) indicating a CSI request for a first beam, and second SL control information including a second CRI indicating a CSI request for a second beam. The reception UE transmits an SL CSI report to the transmission UE. The SL CSI report includes a measurement result, the first CRI, and the second CRI.

### CROSS-REFERENCE TO RELATED APPLICATIONS

This application is the National Stage filing under 35 U.S.C. 371 of International Application No. PCT/KR2021/014681, filed on Oct. 20, 2021, which claims the benefit of Korean Patent Application No. 10-2020-0136128 filed on Oct. 20, 2020, and Korean Patent Application No. 10-2020-0136148 filed on Oct. 20, 2020, which are all hereby incorporated by reference herein in their entirety.

### TECHNICAL FIELD

The present disclosure relates to an efficient method of transmitting sidelink Channel State Information (CSI) reporting for beam management in a millimeter-wave (mmWave) Vehicle-To-Everything (V2X) communication system, and an apparatus for the same.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

Sidelink (SL) refers to a communication method that establishes a direct link between User Equipments (UE) to directly exchange voice or data between UEs without going through a base station. SL is being considered as a way to solve the burden of base stations due to rapidly increasing data traffic.

Vehicle-To-Everything (V2X) refers to a communication technology that exchanges information with other vehicles, pedestrians, infrastructure objects, etc., through wired and wireless communication. V2X may be categorized into four types: Vehicle-To-Vehicle (V2V), Vehicle-To-Infrastructure (V2I), Vehicle-To-Network (V2N), and/or Vehicle-To-Pedestrian (V2P). V2X communication may be provided through the PC5 interface and/or the Uu interface.

### SUMMARY

One aspect of the present disclosure provides a method for transmitting Channel State Information (CSI) for beam management and/or beam refinement to enable SL communications and/or V2X communications in the mmWave band.

One aspect of the present disclosure provides a method for reducing the overhead of CSI transmission by a plurality of beams for CSI transmission to enable SL communication and/or V2X communication in the mmWave band.

One aspect of the present disclosure provides a method for reporting CSI required during beam refinement after initial beam alignment (e.g., beam search) of bidirectional transmit beamforming of UEs engaged in communication for V2X services has been completed.

In an aspect, a method performed by a receiving User Equipment (UE) in a wireless communication system is provided. The method comprises, receiving, from a transmitting UE, a first SL control information comprising a first CSI-RS Resource Index (CRI) indicating a Channel State Information (CSI) request for a first beam, receiving, from the transmitting UE, a second SL control information comprising a second CRI indicating a CSI request for a second beam, and transmitting an SL CSI reporting to the transmitting UE. The SL CSI reporting comprises a result of the measurement, the first CRI and the second CRI.

In another aspect, a method performed by a transmitting User Equipment (UE) in a wireless communication system is provided. The method comprises, transmitting, to a receiving UE, a first SL control information comprising a first CSI-RS Resource Index (CRI) indicating a Channel State Information (CSI) request for a first beam, transmitting, to the receiving UE, a second SL control information comprising a second CRI indicating a CSI request for a second beam, and receiving an SL CSI reporting from the receiving UE. The SL CSI reporting comprises a result of the measurement, the first CRI and the second CRI.

In another aspect, apparatuses implementing the above method are provided.

The present disclosure can have various advantageous effects.

For example, after the initial beam alignment (e.g., beam search) of the bidirectional transmit beamforming of UEs participating in the communication for V2X services has been completed, the necessary SL CSI reporting can be performed during the beam refinement process.

For example, SL CSI reporting can be performed in consideration of the operation of the directional beams.

For example, the overhead of SL CSI reporting by a plurality of beams can be reduced.

For example, SL communications and/or V2X communications can be performed efficiently in the mmWave band.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure are applied.

FIG. 2 shows an example of wireless devices to which implementations of the present disclosure are applied.

FIG. 3 shows an example of a wireless device to which implementations of the present disclosure are applied.

FIG. 4 shows an example of UE to which implementations of the present disclosure are applied.

FIGS. 5 and 6 show an example of protocol stacks in a 3GPP based wireless communication system to which implementations of the present disclosure are applied.

FIG. 7 shows a frame structure in a 3GPP based wireless communication system to which implementations of the present disclosure are applied.

FIG. 8 shows an example of configuration of SL CSI reporting, transmission of CSI-RS, and SL CSI reporting to which implementations of the present disclosure are applied.

FIG. 9 shows another example of configuration of SL CSI reporting, transmission of CSI-RS, and SL CSI reporting to which implementations of the present disclosure are applied.

FIG. 10 shows a method performed by a receiving UE to which implementations of the present disclosure are applied.

FIG. 11 shows a method performed by a transmitting UE to which implementations of the present disclosure are applied.

FIG. 12 shows an example of an SL CSI reporting method to which the first implementation of the present disclosure is applied.

FIG. 13 shows another example of an SL CSI reporting method to which the first implementation of the present disclosure is applied.

FIG. 14 shows another example of an SL CSI reporting method to which the first implementation of the present disclosure is applied.

FIG. 15 shows another example of an SL CSI reporting method to which the first implementation of the present disclosure is applied.

FIG. 16 shows an example of an SL CSI reporting MAC CE according to the second implementation of the present disclosure.

FIG. 17 shows another example of an SL CSI reporting MAC CE according to the second implementation of the present disclosure.

FIG. 18 shows another example of an SL CSI reporting MAC CE according to the second implementation of the present disclosure.

FIG. 19 shows another example of an SL CSI reporting MAC CE according to the second implementation of the present disclosure.

FIG. 20 shows another example of an SL CSI reporting MAC CE according to the second implementation of the present disclosure.

FIG. 21 shows another example of an SL CSI reporting MAC CE according to the second implementation of the present disclosure.

FIG. 22 shows another example of an SL CSI reporting MAC CE according to the second implementation of the present disclosure.

FIG. 23 shows another example of an SL CSI reporting MAC CE according to the second implementation of the present disclosure.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDDCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

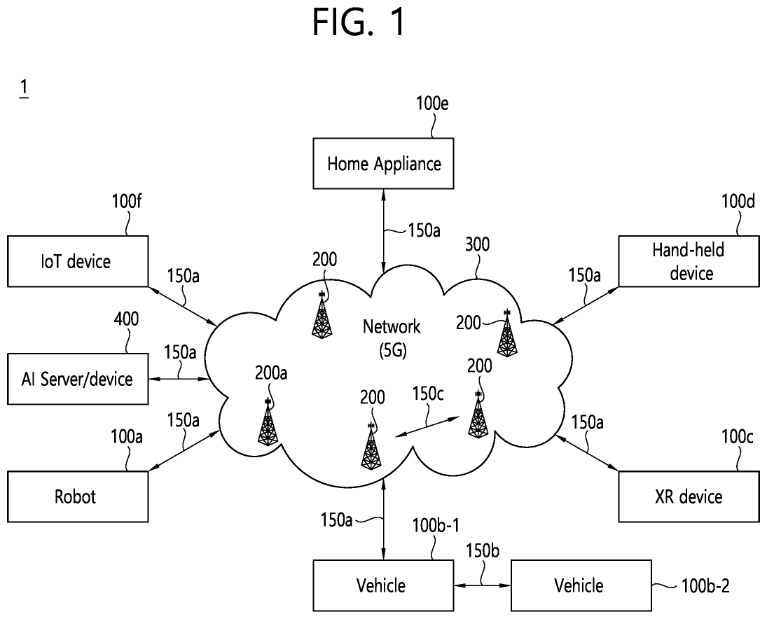

FIG. 1 shows an example of a communication system to which implementations of the present disclosure are applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an eXtended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a Closed-Circuit TV (CCTV), a recorder, or a black box.

The FinTech device may be, for example, a device capable of providing a financial service such as mobile payment. For example, the FinTech device may include a payment device or a Point of Sales (PoS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through Computer Graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding frequency | | |
|---|---|---|---|
| designation | range | Subcarrier Spacing | |
| FR1 | 450 MHz-6000 MHz | 15, 30, 60 | kHz |
| FR2 | 24250 MHz-52600 MHz | 60, 120, 240 | kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding frequency | | |
|---|---|---|---|
| designation | range | Subcarrier Spacing | |
| FR1 | 410 MHz-7125 MHz | 15, 30, 60 | kHz |
| FR2 | 24250 MHz-52600 MHz | 60, 120, 240 | kHz |

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names.

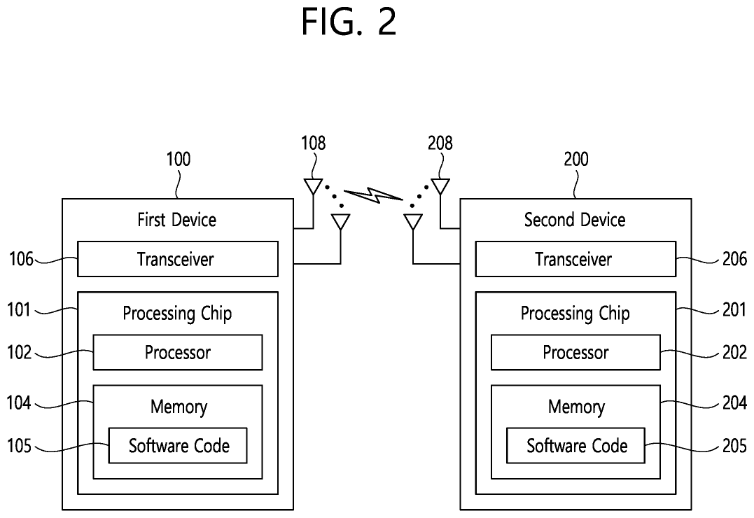

FIG. 2 shows an example of wireless devices to which implementations of the present disclosure are applied.

Referring to FIG. 2, a first wireless device 100 and a second wireless device 200 may transmit/receive radio signals to/from an external device through a variety of RATs (e.g., LTE and NR).

In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be configured to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs) and/or one or more Service Data Units (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable ROMs (EEPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in UL and as a receiving device in DL. In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a Node B (NB), an eNode B (eNB), or a gNB.

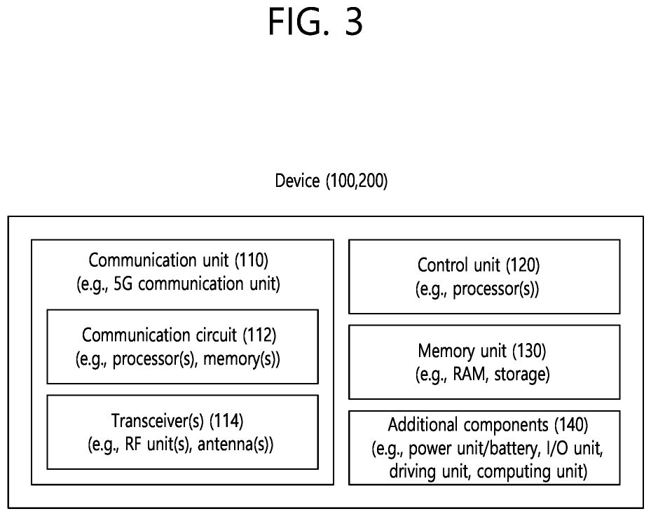

FIG. 3 shows an example of a wireless device to which implementations of the present disclosure are applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, Input/Output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an Application Processor (AP), an Electronic Control Unit (ECU), a Central Processing Unit (CPU), a Graphical Processing Unit (GPU), and a memory control processor. As another example, the memory unit 130 may be configured by a RAM, a Dynamic RAM (DRAM), a ROM, a flash memory, a volatile memory, a non-volatile memory, and/or a combination thereof.

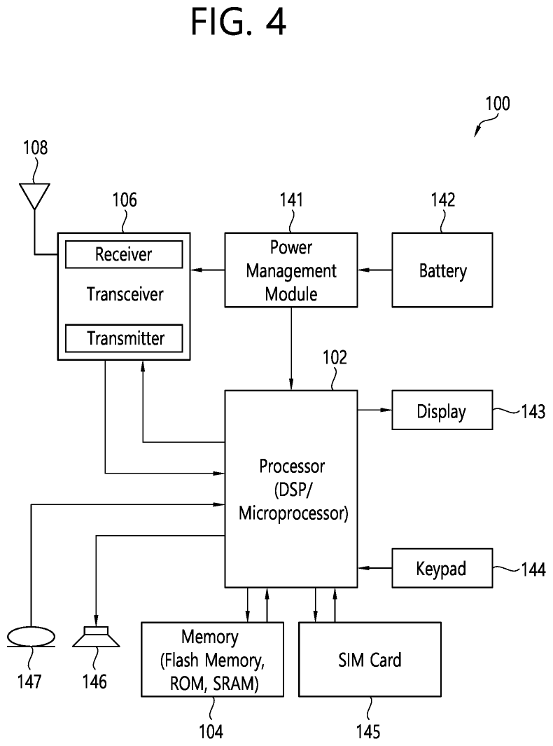

FIG. 4 shows an example of UE to which implementations of the present disclosure are applied.

Referring to FIG. 4, a UE 100 may correspond to the first wireless device 100 of FIG. 2 and/or the wireless device 100 or 200 of FIG. 3.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple⁻, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

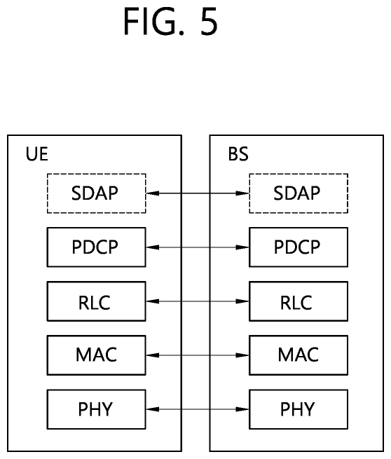

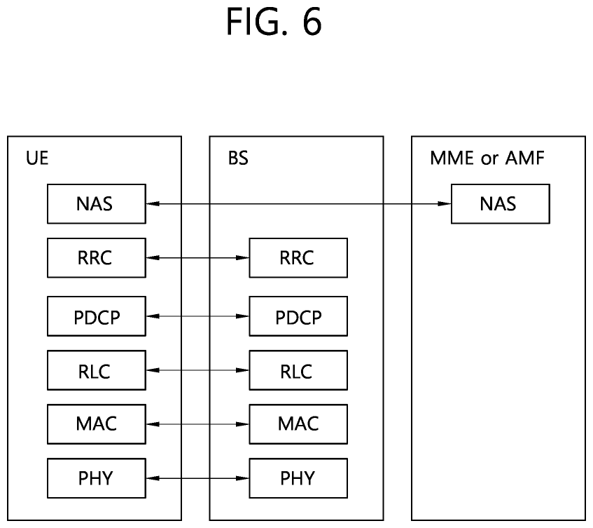

FIGS. 5 and 6 show an example of protocol stacks in a 3GPP based wireless communication system to which implementations of the present disclosure are applied.

In particular, FIG. 5 illustrates an example of a radio interface user plane protocol stack between a UE and a BS and FIG. 6 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 5, the user plane protocol stack may be divided into Layer 1 (i.e., a PHY layer) and Layer 2. Referring to FIG. 6, the control plane protocol stack may be divided into Layer 1 (i.e., a PHY layer), Layer 2, Layer 3 (e.g., an RRC layer), and a Non-Access Stratum (NAS) layer. Layer 1, Layer 2 and Layer 3 are referred to as an Access Stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network Quality of Service (QoS) flows.

In the 3GPP NR system, the main services and functions of the MAC sublayer include: mapping between logical channels and transport channels; multiplexing/de-multiplexing of MAC SDUs belonging to one or different logical channels into/from Transport Blocks (TB) delivered to/from the physical layer on transport channels; scheduling information reporting; error correction through Hybrid Automatic Repeat reQuest (HARQ) (one HARQ entity per cell in case of Carrier Aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast Control Channel (BCCH) is a downlink logical channel for broadcasting system control information, Paging Control Channel (PCCH) is a downlink logical channel that transfers paging information, system information change notifications and indications of ongoing Public Warning Service (PWS) broadcasts, Common Control Channel (CCCH) is a logical channel for transmitting control information between UEs and network and used for UEs having no RRC connection with the network, and Dedicated Control Channel (DCCH) is a point-to-point bi-directional logical channel that transmits dedicated control information between a UE and the network and used by UEs having an RRC connection. Dedicated Traffic Channel (DTCH) is a point-to-point logical channel, dedicated to one UE, for the transfer of user information. A DTCH can exist in both uplink and downlink. In downlink, the following connections between logical channels and transport channels exist: BCCH can be mapped to Broadcast Channel (BCH); BCCH can be mapped to Downlink Shared Channel (DL-SCH); PCCH can be mapped to Paging Channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to Uplink Shared Channel (UL-SCH); DCCH can be mapped to UL-SCH; and DTCH can be mapped to UL-SCH.

The RLC sublayer supports three transmission modes: Transparent Mode (TM), Unacknowledged Mode (UM), and Acknowledged Mode (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using Robust Header Compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS Flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5G Core network (5GC) or Next-Generation Radio Access Network (NG-RAN); establishment, maintenance and release of an RRC connection between the UE and NG-RAN; security functions including key management; establishment, configuration, maintenance and release of Signaling Radio Bearers (SRBs) and Data Radio Bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

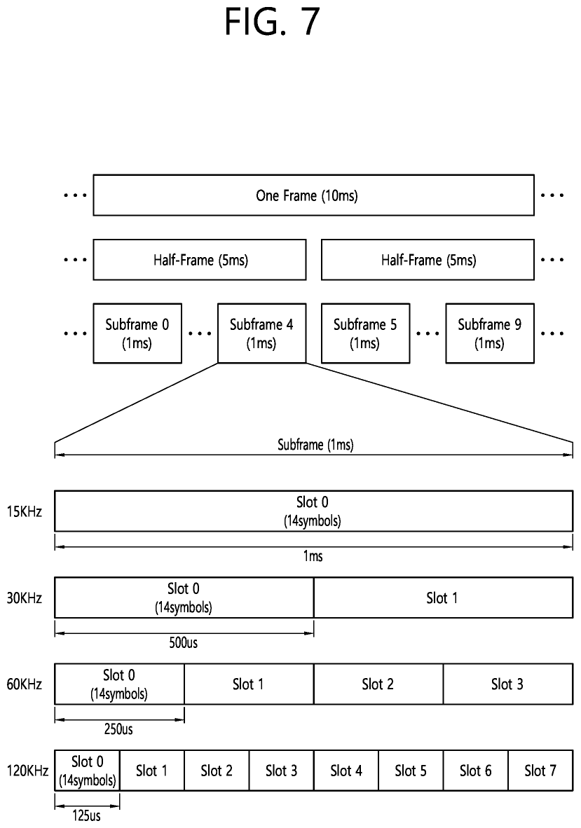

FIG. 7 shows a frame structure in a 3GPP based wireless communication system to which implementations of the present disclosure are applied.

The frame structure shown in FIG. 7 is purely exemplary and the number of subframes, the number of slots, and/or the number of symbols in a frame may be variously changed. In the 3GPP based wireless communication system, OFDM numerologies (e.g., SCS, Transmission Time Interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or Cyclic Prefix (CP)-OFDM symbols), SC-FDMA symbols (or Discrete Fourier Transform-spread-OFDM (DFT-s-OFDM) symbols).

Referring to FIG. 7, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a CP. In a normal CP, each slot includes 14 OFDM symbols and, in an extended CP, each slot includes 12 OFDM symbols. The numerology is based on exponentially scalable subcarrier spacing Δf=2^{u}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at Common Resource Block (CRB) N^{start,u}_{grid} indicated by higher-layer signaling (e.g., RRC signaling), where N^{size,u}_{grid,x} is the number of Resource Blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a Resource Element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain.

In the 3GPP NR system, RBs are classified into CRBs and Physical Resource Blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a BandWidth Part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the PHY layer, the uplink transport channels UL-SCH and Random Access Channel (RACH) are mapped to their physical channels Physical Uplink Shared Channel (PUSCH) and Physical Random Access Channel (PRACH), respectively, and the downlink transport channels DL-SCH, BCH and PCH are mapped to Physical Downlink Shared Channel (PDSCH), Physical Broadcast Channel (PBCH) and PDSCH, respectively. In the PHY layer, Uplink Control Information (UCI) is mapped to PUCCH, and Downlink Control Information (DCI) is mapped to Physical Downlink Control Channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Hereinafter, Vehicle-To-Everything (V2X) communications and/or Sidelink (SL) communications are described.

For example, the UE1 may select a resource unit corresponding to a particular resource within a resource pool, which is a set of resources. The UE1 may then transmit an SL signal using the resource unit. For example, the UE2, the receiving UE, may be configured with a resource pool over which the UE1 may transmit the signal, and may detect the signal of UE1 within the resource pool.

Here, if the UE1 is within the connectivity range of the base station, the base station may inform the UE1 of the resource pool. On the other hand, if the UE1 is out of the connectivity range of the base station, another UE may inform the UE1 of the resource pool, or the UE1 may use a preconfigured resource pool.

In general, a resource pool may consist of a plurality of resource units, and each UE may select one or more resource units to use for its SL signal transmission.

A resource unit may appear periodically and repeatedly. Alternatively, the index of the physical resource unit to which one logical resource unit is mapped may vary over time in a predetermined pattern, in order to achieve a diversity effect in the time or frequency domain. In terms of the structure of these resource units, a resource pool may refer to a set of resource units that are available for transmission by a UE that wishes to transmit SL signaling.

Hereinafter, resource allocation in SL is described.

A UE may perform V2X communication and/or SL communication depending on the transmission mode. The transmission mode may be referred to as a mode and/or a resource allocation mode. The transmission mode in an LTE system may be referred to as an LTE transmission mode, and the transmission mode in an NR system may be referred to as an NR resource allocation mode. LTE transmission mode 1/2 may be applied to general SL communication, and LTE transmission mode 3/4 may be applied to V2X communication.

In LTE transmission mode 1, LTE transmission mode 3, and/or NR resource allocation mode 1, the base station may schedule the SL resources to be used by the UEs for SL transmission. For example, the base station may perform resource scheduling by transmitting a DCI via PDCCH to UE1, and UE1 may perform V2X communication and/or SL communication with UE2 based on the resource scheduling. For example, UE1 may transmit Sidelink Control Information (SCI) to UE2 via a Physical Sidelink Control Channel (PSCCH), and then transmit data based on the SCI to UE2 via a Physical Sidelink Shared Channel (PSSCH).

For example, in NR resource allocation mode 1, the UE may be provided and/or allocated resources for one or more SL transmissions of one TB by the base station via dynamic grant. For example, the base station may provide resources to the UE for the transmission of PSCCH and/or PSSCH using dynamic grant. For example, the transmitting UE may report to the base station the SL HARQ feedback received from the receiving UE. In this case, the PUCCH resources and timing for reporting the SL HARQ feedback to the base station may be determined based on the instructions in the PDCCH for the base station to allocate resources for SL transmission.

For example, in NR resource allocation mode 1, the UE may periodically be provided and/or allocated a set of resources for a plurality of SL transmissions by the base station via a configured grant. For example, the configured grant may include a configured grant type 1 or a configured grant type 2. For example, the UE may determine the TB to be transmitted at each of the occasions indicated by a given configured grant.

In LTE transmission mode 2, LTE transmission mode 4, and/or NR resource allocation mode 2, the UE may determine the SL transmission resource within the SL resource configured by the base station/network and/or the preconfigured SL resource. For example, the configured SL resource and/or the preconfigured SL resource may be a resource pool. For example, the UE may autonomously select or schedule resources for SL transmission. For example, the UE may autonomously select a resource within the configured resource pool to perform V2X communication and/or SL communication. For example, the UE may perform a sensing and resource (re)selection procedure to autonomously select a resource within a selection window. For example, the sensing may be performed on a subchannel unit. Then, upon autonomously selecting a resource within the resource pool, UE1 may transmit a SCI to UE2 via PSCCH, and then transmit data based on the SCI to UE2 via PSSCH.

Hereinafter, SL measurement and reporting are described.

SL measurement and reporting between UEs may be considered in SL for purposes such as QoS prediction, initial transmission parameter setting, link adaptation, link management, admission control, etc. For example, a receiving UE may receive a reference signal from a transmitting UE, and the receiving UE may measure a channel state (e.g., Reference Signal Received Power (RSRP) and/or Reference Signal Received Quality (RSRQ)) for the transmitting UE based on the reference signal. The receiving UE may then report Channel State Information (CSI) to the transmitting UE. SL-related measurement and reporting may include measurement and reporting of Channel Busy Ratio (CBR) and/or reporting of location information. Examples of CSIs for V2X communications may include Channel Quality Indicator (CQI), Precoding Matrix Index (PMI), Rank Indicator (RI), RSRP, RSRQ, pathgain/pathloss, Sounding Reference Symbols (SRS) Resource Indicator (SRI), CSI-RS Resource Indicator (CRI), interference condition, vehicle motion, etc. For unicast communications, CQI, RI, and PMI, or some of them, may be supported in a non-subband-based aperiodic CSI report assuming four or fewer antenna ports. The CSI procedure may not rely on a standalone reference signal. CSI reporting may be enabled and disabled based on configurations.

For example, a transmitting UE may transmit a CSI-RS to a receiving UE, and the receiving UE may utilize the CSI-RS to measure CQI and/or RI. For example, the CSI-RS may be referred to as a SL CSI-RS. For example, said CSI-RS may be confined within a PSSCH transmission. For example, the transmitting UE may include the CSI-RS in the PSSCH resource and transmit it to the receiving UE.

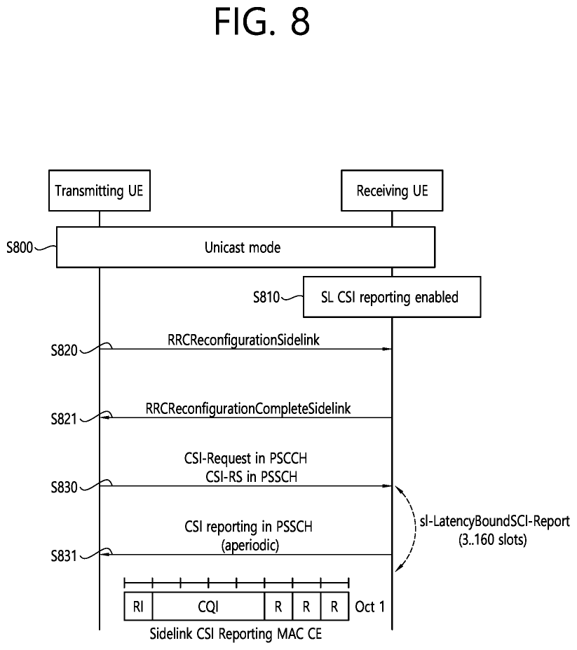

FIG. 8 shows an example of configuration of SL CSI reporting, transmission of CSI-RS, and SL CSI reporting to which implementations of the present disclosure are applied.

In step S800, the transmitting UE and the receiving UE may communicate in unicast mode. That is, the transmitting UE and the receiving UE may perform SL communication and/or V2X communication via a unicast link.

In step S810, the receiving UE may be enabled to report SL CSI. For example, if the sl-CSI-Acquisition field, which may be received and/or configured via broadcast signaling (e.g., SIB12), dedicated signaling (e.g., SL-ConfigDedicatedNR), and/or preconfiguration (e.g., SL-PreconfigurationNR), is set to “True”, SL CSI reporting may be enabled in SL unicast. Otherwise (e.g., if the sl-CSI-Acquisition field is not set to “True” and/or the sl-CSI-Acquisition field is not present), SL CSI reporting may be disabled.

In step S820, the transmitting UE may transmit an SL RRC reconfiguration message (e.g., RRCReconfigurationSidelink) to the receiving UE. For example, the SL RRC reconfiguration message may include CSI-RS configurations.

In step S821, in response to the SL RRC reconfiguration message, the receiving UE may transmit an SL RRC reconfiguration complete message (e.g., RRCReconfigurationCompleteSidelink) to the transmitting UE.

In step S830, the transmitting UE may transmit a CSI request (CSI-Request) via PSCCH to the receiving UE. For example, the CSI request may be a 1-bit indicator in the SCI transmitted via the PSCCH. Further, the transmitting UE may transmit a CSI-RS via PSSCH to the receiving UE.

In step S831, the receiving UE may transmit an SL CSI reporting via PSSCH to the transmitting UE. For example, the receiving UE may measure the received CSI-RS to derive a CQI and/or RI, and may generate an SL CSI reporting MAC Control Element (CE) including the derived CQI and/or RI and report it to the transmitting UE. For example, the SL CSI reporting may be transmitted aperiodically.

The SL CSI reporting may be transmitted within a period of time after the CSI request is received in step S830. For example, the SL CSI latency bound (e.g., sl-LatencyBoundCSI-Report) may be configured via the SL RRC reconfiguration message received in step S820, which may have a value of any one of 3 to 160 slots. The receiving UE may, after receiving the CSI request, transmit an SL CSI reporting to the transmitting UE within the SL CSI latency boundary.

In the future, it may be expected that SL communication and/or V2X communication will be performed in the mmWave band. In this case, the UE may need to report CSI considering the available beam. Furthermore, the information transmitted via CSI may also need to include RSRP/Signal-to-Noise Ratio (SNR), as well as the CQI and/or RI.

More specifically, communication in the mmWave band may require the use of a directional beam to offset attenuation due to path loss due to the nature of propagation. However, current procedures for SL communications and/or V2X communications do not consider the characteristics of directional beams, i.e., CSI reporting does not consider features related to the operation of the beam and does not include information related to the beam. As a result, SL communication and/or V2X communication in the mmWave band may not be performed efficiently.

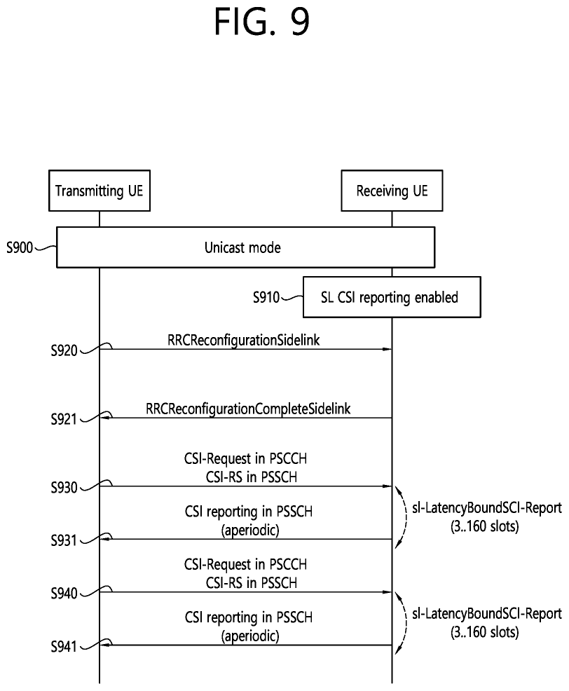

FIG. 9 shows another example of configuration of SL CSI reporting, transmission of CSI-RS, and SL CSI reporting to which implementations of the present disclosure are applied.

The operations of steps S900 through S931 may correspond and/or be the same as the operations of steps S800 through S831 described in FIG. 8, respectively.

In step S940, the transmitting UE may transmit a CSI request via the PSCCH to the receiving UE. For example, the CSI request may be a 1-bit indicator in the SCI transmitted via the PSCCH. Further, the transmitting UE may transmit a CSI-RS via PSSCH to the receiving UE.

In step S941, the receiving UE may transmit an SL CSI reporting via PSSCH to the transmitting UE. For example, the receiving UE may measure the received CSI-RS to derive a CQI and/or RI, and generate an SL CSI reporting MAC CE including the derived CQI and/or RI for reporting to the transmitting UE. For example, the SL CSI reporting may be transmitted aperiodically.

The SL CSI reporting may be transmitted within a period of time after the CSI request is received in step S940. For example, the SL CSI latency bound (e.g., sl-LatencyBoundCSI-Report) may be configured via the SL RRC reconfiguration message received in step S920, which may have a value of any one of 3 to 160 slots. The receiving UE may, after receiving the CSI request, transmit an SL CSI reporting to the transmitting UE within the SL CSI latency boundary.

Compared to the operation of FIG. 8, the operation of FIG. 9 considers measuring the CSI-RS transmitted via a plurality of beams and performing an SL CSI reporting thereon. Even when operating multiple directional beams, if the CSI-RS transmission and SL CSI reporting are performed sequentially as shown in FIG. 9 (i.e., S930/S931 followed by S940/S941), it is possible to know which CSI-RS and/or CSI-RS resource the SL CSI reporting corresponds to without the CSI-RS Resource Index (CRI) information.

However, if the number of beams is large, it may be time consuming to perform all SL CSI reportings for all beams.

Hereinafter, according to implementations of the present disclosure, a method that reduces the transmission burden of SL CSI reporting by including in the SL CSI the SL CSI for a plurality of CSI-RS resources corresponding to a plurality of beams respectively is described.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

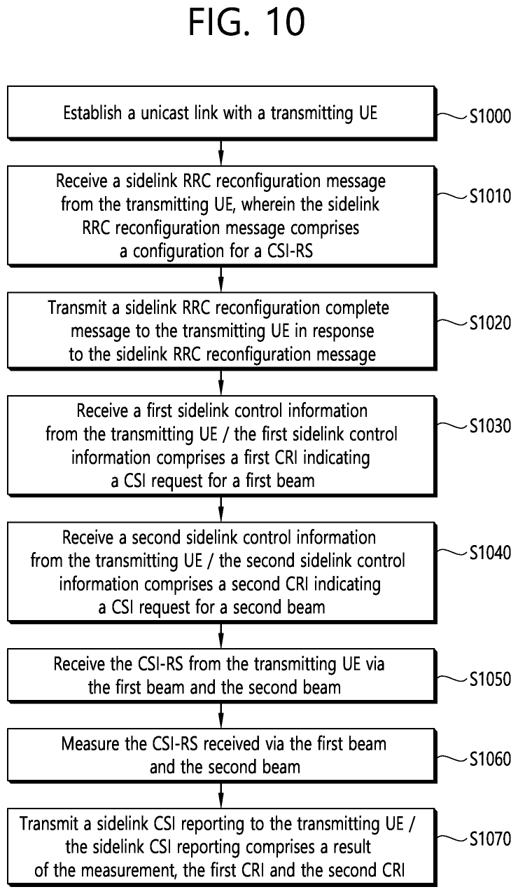

FIG. 10 shows a method performed by a receiving UE to which implementations of the present disclosure are applied.

In step S1000, the method comprises establishing a unicast link with a transmitting UE.

In step S1010, the method comprises receiving a SL RRC reconfiguration message from the transmitting UE. The SL RRC reconfiguration message comprises a configuration for a CSI-RS. Furthermore, the SL RRC reconfiguration message may comprise a configuration to enable the SL CSI reporting to include a CRI and a RSRP.

In step S1020, the method comprises transmitting an SL RRC reconfiguration complete message to the transmitting UE in response to the SL RRC reconfiguration message.

In step S1030, the method comprises receiving a first SL control information from the transmitting UE. The first SL control information comprises a first CRI indicating a CSI request for a first beam.

In step S1040, the method comprises receiving a second SL control information from the transmitting UE. The second SL control information comprises a second CRI indicating a CSI request for a second beam;

In step S1050, the method comprises receiving the CSI-RS from the transmitting UE via the first beam and the second beam.

In step S1060, the method comprises measuring the CSI-RS received via the first beam and the second beam.

In step S1070, the method comprises transmitting an SL CSI reporting to the transmitting UE. The SL CSI reporting comprises a result of the measurement, the first CRI and the second CRI.

In some implementations, the first CRI included in the first SL control information and/or the second CRI included in the second SL control information may have a size greater than one bit (e.g., 6 bits).

In some implementations, after the first SL control information is received, the CSI-RS may be received via the first beam after X slot. Furthermore, after the first SL control information is received, the SL CSI reporting may be transmitted after Y slot.

In some implementations, the CSI-RS received via the first beam and the CSI-RS received via the second beam may be received at regular periods.

In some implementations, the SL CSI reporting may be transmitted within an SL CSI latency boundary configured in the SL RRC reconfiguration message from after the first SL control information is received.

In some implementations, the first CRI included in the first SL control information and/or the second CRI included in the second SL control information may have a size of 1 bit. In this case, the CSI-RS received via the first beam and the CSI-RS received via the second beam may be received via different dynamically allocated time resources.

In some implementations, the first beam and a beam of the transmitting UE may be aligned with each other in a Physical Sidelink Feedback Channel (PSFCH) cycle of a receiving pool, within an SL CSI latency boundary configured in the SL RRC reconfiguration message from after the first SL control information is received. Alternatively, first beam and a beam of the transmitting UE may be aligned with each other in a slot corresponding to a multiple of a beam alignment cycle check parameter received by an upper layer, within an SL CSI latency boundary configured in the SL RRC reconfiguration message from after the first SL control information is received.

In some implementations, the first CRI and/or the second CRI included in the SL CSI reporting may have a size of at least 7 bits.

In some implementations, the result of the measurement included in the SL CSI reporting may comprise an RSRP of the CSI-RS received via the first beam and an RSRP of the CSI-RS received via the second beam. In this case, the RSRP of the CSI-RS received via the first beam may have a size of 7 bits, and the RSRP of the CSI-RS received via the second beam may have a size of 4 bits.

In some implementations, the first CRI and/or the second CRI included in the SL CSI reporting may be expressed as an offset value of 4 bits relative to a representative CRI.

In some implementations, the receiving UE may be in communication with at least one of a mobile device, a network, and/or autonomous vehicles other than the receiving UE.

Furthermore, the method in perspective of the receiving UE described above in FIG. 10 may be performed by the first wireless device 100 shown in FIG. 2, the wireless device 100 shown in FIG. 3, and/or the UE 100 shown in FIG. 4.

More specifically, the receiving UE comprises at least one transceiver, at least one processor, and at least one memory operably connectable to the at least one processor and storing instructions that, based on being executed by the at least one processor, perform operations below.

The receiving UE establishes a unicast link with a transmitting UE.

The receiving UE receives, via the at least one transceiver, a SL RRC reconfiguration message from the transmitting UE. The SL RRC reconfiguration message comprises a configuration for a CSI-RS. Furthermore, the SL RRC reconfiguration message may comprise a configuration to enable the SL CSI reporting to include a CRI and a RSRP.

The receiving UE transmits, via the at least one transceiver, an SL RRC reconfiguration complete message to the transmitting UE in response to the SL RRC reconfiguration message.

The receiving UE receives, via the at least one transceiver, a first SL control information from the transmitting UE. The first SL control information comprises a first CRI indicating a CSI request for a first beam.

The receiving UE receives, via the at least one transceiver, a second SL control information from the transmitting UE. The second SL control information comprises a second CRI indicating a CSI request for a second beam;

The receiving UE receives, via the at least one transceiver, the CSI-RS from the transmitting UE via the first beam and the second beam.

The receiving UE measures the CSI-RS received via the first beam and the second beam.

The receiving UE transmits, via the at least one transceiver, an SL CSI reporting to the transmitting UE. The SL CSI reporting comprises a result of the measurement, the first CRI and the second CRI.

In some implementations, the first CRI included in the first SL control information and/or the second CRI included in the second SL control information may have a size greater than one bit (e.g., 6 bits).

In some implementations, after the first SL control information is received, the CSI-RS may be received via the first beam after X slot. Furthermore, after the first SL control information is received, the SL CSI reporting may be transmitted after Y slot.

In some implementations, the CSI-RS received via the first beam and the CSI-RS received via the second beam may be received at regular periods.

In some implementations, the SL CSI reporting may be transmitted within an SL CSI latency boundary configured in the SL RRC reconfiguration message from after the first SL control information is received.

In some implementations, the first CRI included in the first SL control information and/or the second CRI included in the second SL control information may have a size of 1 bit. In this case, the CSI-RS received via the first beam and the CSI-RS received via the second beam may be received via different dynamically allocated time resources.

In some implementations, the first beam and a beam of the transmitting UE may be aligned with each other in a Physical Sidelink Feedback Channel (PSFCH) cycle of a receiving pool, within an SL CSI latency boundary configured in the SL RRC reconfiguration message from after the first SL control information is received. Alternatively, first beam and a beam of the transmitting UE may be aligned with each other in a slot corresponding to a multiple of a beam alignment cycle check parameter received by an upper layer, within an SL CSI latency boundary configured in the SL RRC reconfiguration message from after the first SL control information is received.

In some implementations, the first CRI and/or the second CRI included in the SL CSI reporting may have a size of at least 7 bits.

In some implementations, the result of the measurement included in the SL CSI reporting may comprise an RSRP of the CSI-RS received via the first beam and an RSRP of the CSI-RS received via the second beam. In this case, the RSRP of the CSI-RS received via the first beam may have a size of 7 bits, and the RSRP of the CSI-RS received via the second beam may have a size of 4 bits.

In some implementations, the first CRI and/or the second CRI included in the SL CSI reporting may be expressed as an offset value of 4 bits relative to a representative CRI.

In some implementations, the receiving UE may be in communication with at least one of a mobile device, a network, and/or autonomous vehicles other than the receiving UE.

Furthermore, the method in perspective of the receiving UE described above in FIG. 10 may be performed by control of the processor 102 included in the first wireless device 100 shown in FIG. 2, by control of the communication unit 110 and/or the control unit 120 included in the wireless device 100 shown in FIG. 3, and/or by control of the processor 102 included in the UE 100 shown in FIG. 4.

More specifically, a processing apparatus operating in a wireless communication system comprises at least one processor, and at least one memory operably connectable to the at least one processor. The at least one processor is adapted to perform operations comprising: obtaining a SL RRC reconfiguration message, wherein the SL RRC reconfiguration message comprises a configuration for a CSI-RS; generating an SL RRC reconfiguration complete message; obtaining a first SL control information, wherein the first SL control information comprises a first CRI indicating a CSI request for a first beam; obtaining a second SL control information, wherein the second SL control information comprises a second CRI indicating a CSI request for a second beam; obtaining the CSI-RS via the first beam and the second beam; measuring the CSI-RS obtained via the first beam and the second beam; and generating an SL CSI reporting. The SL CSI reporting comprises a result of the measurement, the first CRI and the second CRI.

Furthermore, the method in perspective of the receiving UE described above in FIG. 10 may be performed by a software code 105 stored in the memory 104 included in the first wireless device 100 shown in FIG. 2.

The technical features of the present disclosure may be embodied directly in hardware, in a software executed by a processor, or in a combination of the two. For example, a method performed by a wireless device in a wireless communication may be implemented in hardware, software, firmware, or any combination thereof. For example, a software may reside in RAM, flash memory, ROM, EPROM, EEPROM, registers, hard disk, a removable disk, a CD-ROM, or any other storage medium.

Some example of storage medium may be coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include RAM such as synchronous dynamic random access memory (SDRAM), ROM, non-volatile random access memory (NVRAM), EEPROM, flash memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some implementations of the present disclosure, a non-transitory computer-readable medium (CRM) has stored thereon a plurality of instructions.

More specifically, at least one CRM stores instructions that, based on being executed by at least one processor, perform operations comprising: obtaining a SL RRC reconfiguration message, wherein the SL RRC reconfiguration message comprises a configuration for a Channel State Information Reference Signal (CSI-RS); generating an SL RRC reconfiguration complete message; obtaining a first SL control information, wherein the first SL control information comprises a first CRI indicating a CSI request for a first beam; obtaining a second SL control information, wherein the second SL control information comprises a second CRI indicating a CSI request for a second beam; obtaining the CSI-RS via the first beam and the second beam; measuring the CSI-RS obtained via the first beam and the second beam; and generating an SL CSI reporting. The SL CSI reporting comprises a result of the measurement, the first CRI and the second CRI.

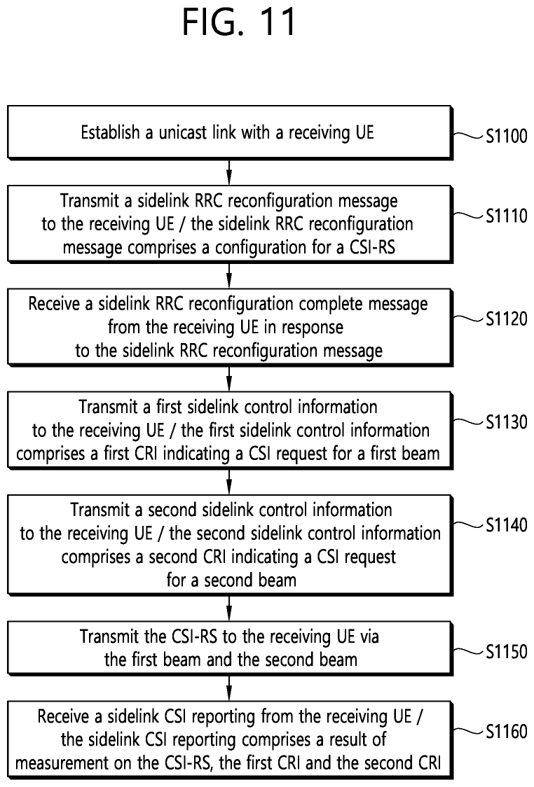

FIG. 11 shows a method performed by a transmitting UE to which implementations of the present disclosure are applied.

In step S1100, the method comprises establishing a unicast link with a receiving UE;

In step S1110, the method comprises transmitting a SL RRC reconfiguration message to the receiving UE. The SL RRC reconfiguration message comprises a configuration for a CSI-RS. Furthermore, the SL RRC reconfiguration message may comprise a configuration to enable the SL CSI reporting to include a CRI and a RSRP.

In step S1120, the method comprises receiving an SL RRC reconfiguration complete message from the receiving UE in response to the SL RRC reconfiguration message.

In step S1130, the method comprises transmitting a first SL control information to the receiving UE. The first SL control information comprises a first CRI indicating a CSI request for a first beam.

In step S1140, the method comprises transmitting a second SL control information to the receiving UE, wherein the second SL control information comprises a second CRI indicating a CSI request for a second beam.

In step S1150, the method comprises transmitting the CSI-RS to the receiving UE via the first beam and the second beam.

In step S1160, the method comprises receiving an SL CSI reporting from the receiving UE. The SL CSI reporting comprises a result of measurement on the CSI-RS, the first CRI and the second CRI.

In some implementations, the first CRI included in the first SL control information and/or the second CRI included in the second SL control information may have a size greater than one bit (e.g., 6 bits).

In some implementations, after the first SL control information is transmitted, the CSI-RS may be transmitted via the first beam after X slot. Furthermore, after the first SL control information is transmitted, the SL CSI reporting may be received after Y slot.

In some implementations, the CSI-RS transmitted via the first beam and the CSI-RS transmitted via the second beam may be transmitted at regular periods.

In some implementations, the SL CSI reporting may be received within an SL CSI latency boundary configured in the SL RRC reconfiguration message from after the first SL control information is transmitted.

In some implementations, the first CRI included in the first SL control information and/or the second CRI included in the second SL control information may have a size of 1 bit. In this case, the CSI-RS transmitted via the first beam and the CSI-RS transmitted via the second beam may be transmitted via different dynamically allocated time resources.

In some implementations, the first beam and a beam of the receiving UE may be aligned with each other in a Physical Sidelink Feedback Channel (PSFCH) cycle of a receiving pool, within an SL CSI latency boundary configured in the SL RRC reconfiguration message from after the first SL control information is transmitted. Alternatively, first beam and a beam of the receiving UE may be aligned with each other in a slot corresponding to a multiple of a beam alignment cycle check parameter received by an upper layer, within an SL CSI latency boundary configured in the SL RRC reconfiguration message from after the first SL control information is transmitted.

In some implementations, the first CRI and/or the second CRI included in the SL CSI reporting may have a size of at least 7 bits.

In some implementations, the result of the measurement included in the SL CSI reporting may comprise an RSRP of the CSI-RS transmitted via the first beam and an RSRP of the CSI-RS transmitted via the second beam. In this case, the RSRP of the CSI-RS transmitted via the first beam may have a size of 7 bits, and the RSRP of the CSI-RS transmitted via the second beam may have a size of 4 bits.

In some implementations, the first CRI and/or the second CRI included in the SL CSI reporting may be expressed as an offset value of 4 bits relative to a representative CRI.

In some implementations, the transmitting UE may be in communication with at least one of a mobile device, a network, and/or autonomous vehicles other than the transmitting UE.

Furthermore, the method in perspective of the transmitting UE described above in FIG. 11 may be performed by the second wireless device 200 shown in FIG. 2, the wireless device 100 shown in FIG. 3, and/or the UE 100 shown in FIG. 4.

More specifically, the transmitting UE comprises at least one transceiver, at least one processor, and at least one memory operably connectable to the at least one processor and storing instructions that, based on being executed by the at least one processor, perform operations below.

The transmitting UE establishes a unicast link with a receiving UE;

The transmitting UE transmits, via the at least one transceiver, a SL RRC reconfiguration message to the receiving UE. The SL RRC reconfiguration message comprises a configuration for a CSI-RS. Furthermore, the SL RRC reconfiguration message may comprise a configuration to enable the SL CSI reporting to include a CRI and a RSRP.

The transmitting UE receives, via the at least one transceiver, an SL RRC reconfiguration complete message from the receiving UE in response to the SL RRC reconfiguration message.

The transmitting UE transmits, via the at least one transceiver, a first SL control information to the receiving UE. The first SL control information comprises a first CRI indicating a CSI request for a first beam.

The transmitting UE transmits, via the at least one transceiver, a second SL control information to the receiving UE, wherein the second SL control information comprises a second CRI indicating a CSI request for a second beam.

The transmitting UE transmits, via the at least one transceiver, the CSI-RS to the receiving UE via the first beam and the second beam.

The transmitting UE receives, via the at least one transceiver, an SL CSI reporting from the receiving UE. The SL CSI reporting comprises a result of measurement on the CSI-RS, the first CRI and the second CRI.

In some implementations, the first CRI included in the first SL control information and/or the second CRI included in the second SL control information may have a size greater than one bit (e.g., 6 bits).

In some implementations, after the first SL control information is transmitted, the CSI-RS may be transmitted via the first beam after X slot. Furthermore, after the first SL control information is transmitted, the SL CSI reporting may be received after Y slot.

In some implementations, the CSI-RS transmitted via the first beam and the CSI-RS transmitted via the second beam may be transmitted at regular periods.

In some implementations, the SL CSI reporting may be received within an SL CSI latency boundary configured in the SL RRC reconfiguration message from after the first SL control information is transmitted.

In some implementations, the first CRI included in the first SL control information and/or the second CRI included in the second SL control information may have a size of 1 bit. In this case, the CSI-RS transmitted via the first beam and the CSI-RS transmitted via the second beam may be transmitted via different dynamically allocated time resources.

In some implementations, the first beam and a beam of the receiving UE may be aligned with each other in a Physical Sidelink Feedback Channel (PSFCH) cycle of a receiving pool, within an SL CSI latency boundary configured in the SL RRC reconfiguration message from after the first SL control information is transmitted. Alternatively, first beam and a beam of the receiving UE may be aligned with each other in a slot corresponding to a multiple of a beam alignment cycle check parameter received by an upper layer, within an SL CSI latency boundary configured in the SL RRC reconfiguration message from after the first SL control information is transmitted.

In some implementations, the first CRI and/or the second CRI included in the SL CSI reporting may have a size of at least 7 bits.

In some implementations, the result of the measurement included in the SL CSI reporting may comprise an RSRP of the CSI-RS transmitted via the first beam and an RSRP of the CSI-RS transmitted via the second beam. In this case, the RSRP of the CSI-RS transmitted via the first beam may have a size of 7 bits, and the RSRP of the CSI-RS transmitted via the second beam may have a size of 4 bits.

In some implementations, the first CRI and/or the second CRI included in the SL CSI reporting may be expressed as an offset value of 4 bits relative to a representative CRI.

In some implementations, the transmitting UE may be in communication with at least one of a mobile device, a network, and/or autonomous vehicles other than the transmitting UE.

Furthermore, the method in perspective of the transmitting UE described above in FIG. 11 may be performed by control of the processor 202 included in the second wireless device 200 shown in FIG. 2, by control of the communication unit 110 and/or the control unit 120 included in the wireless device 100 shown in FIG. 3, and/or by control of the processor 102 included in the UE 100 shown in FIG. 4.

More specifically, a processing apparatus operating in a wireless communication system comprises at least one processor, and at least one memory operably connectable to the at least one processor. The at least one processor is adapted to perform operations comprising: generating a SL RRC reconfiguration message, wherein the SL RRC reconfiguration message comprises a configuration for a CSI-RS; obtaining an SL RRC reconfiguration complete message; generating a first SL control information, wherein the first SL control information comprises a first CRI indicating a CSI request for a first beam; generating a second SL control information, wherein the second SL control information comprises a second CRI indicating a CSI request for a second beam; generating the CSI-RS to be transmitted via the first beam and the second beam; and obtaining an SL CSI reporting. The SL CSI reporting comprises a result of measurement on the CSI-RS, the first CRI and the second CRI.

Furthermore, the method in perspective of the transmitting UE described above in FIG. 11 may be performed by a software code 205 stored in the memory 204 included in the second wireless device 200 shown in FIG. 2.

More specifically, at least one CRM stores instructions that, based on being executed by at least one processor, perform operations comprising: generating a SL RRC reconfiguration message, wherein the SL RRC reconfiguration message comprises a configuration for a CSI-RS; obtaining an SL RRC reconfiguration complete message; generating a first SL control information, wherein the first SL control information comprises a first CRI indicating a CSI request for a first beam; generating a second SL control information, wherein the second SL control information comprises a second CRI indicating a CSI request for a second beam; generating the CSI-RS to be transmitted via the first beam and the second beam; and obtaining an SL CSI reporting. The SL CSI reporting comprises a result of measurement on the CSI-RS, the first CRI and the second CRI.

Hereinafter, various implementations of the present disclosure are described.

1. First Implementation

Currently, CSI reporting at the Uu interface (i.e., UL) considers directional beams, and UL CSI reporting is transmitted to the network via PUCCH and/or PUSCH. On the other hand, current SL CSI reporting does not consider directional beams, and SL CSI reporting is performed aperiodically based on aperiodically received CSI-RS. Furthermore, SL CSI reporting is transmitted via a MAC CE consisting of 5 bits.

To maintain consistency between UL CSI reporting and SL CSI reporting, the first implementation of the present disclosure provides a method for SL CSI reporting that reuses the operations and/or implementations of UL CSI reporting to the extent possible, while minimizing complexity.

Further, the first implementation of the present disclosure provides a method for aligning SL CSI request and SL CSI reporting so that the beams are not misaligned with each other during SL CSI reporting.

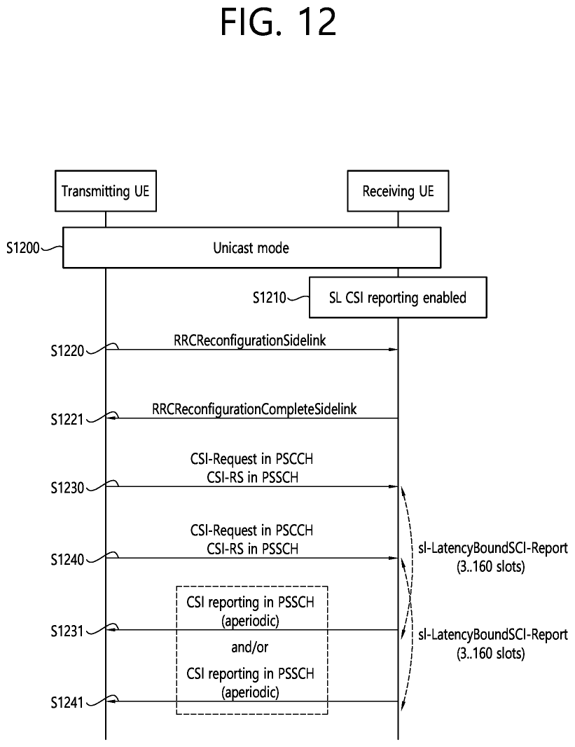

FIG. 12 shows an example of an SL CSI reporting method to which the first implementation of the present disclosure is applied.

In the operation of FIG. 12 for SL CSI reporting for a plurality of beams, one cycle of SL CSI reporting, comprising CSI-RS transmission and SL CSI reporting, may be overlapped for each beam. Accordingly, the time required for SL CSI reporting may be reduced. However, since there may be ambiguity as to which SL CSI reporting transmitted by the receiving UE is associated with the CSI-RS resource received via which beam, SL CSI may be reported by associating each CSI-RS with a CRI and including the corresponding CRI in the SL CSI reporting.

Also, rather than transmitting an SL CSI reporting for each CSI-RS received via a particular beam on a beam-by-beam basis, a single SL CSI reporting may include the SL CSI for multiple CSI-RSs. Accordingly, the transmission burden of SL CSI reporting can be reduced.

In the operation of FIG. 12, the size of the SL CSI request field in the SCI transmitted via PSCCH may be extended from 1 bit to X bits. For example, X bits may be 6 bits. In this case, the SL CSI request field may correspond to the CRI of the corresponding CSI-RS. The SL CSI request field may also correspond to the beam on which the CSI-RS is transmitted. The SL CSI reporting may include a measurement result of a CSI-RS transmitted via a particular beam and a CRI corresponding to that CSI-RS.

In step S1200, the transmitting UE and the receiving UE may communicate in unicast mode. That is, the transmitting UE and the receiving UE may perform SL communication and/or V2X communication via a unicast link.

In step S1210, the receiving UE may be enabled to report SL CSI. For example, if the sl-CSI-Acquisition field, which may be received and/or configured via broadcast signaling (e.g., SIB12), dedicated signaling (e.g., SL-ConfigDedicatedNR), and/or preconfiguration (e.g., SL-PreconfigurationNR), is set to “True”, SL CSI reporting may be enabled in SL unicast. Otherwise (e.g., if the sl-CSI-Acquisition field is not set to “True” and/or the sl-CSI-Acquisition field is not present), SL CSI reporting may be disabled.

In step S1220, the transmitting UE may transmit an SL RRC reconfiguration message (e.g., RRCReconfigurationSidelink) to the receiving UE.

The SL RRC reconfiguration message may include the SL CSI measurement configuration (e.g., SL-CSI-MeasConfig). Table 5 shows an example of an SL CSI measurement configuration.

```
TABLE 5
SL-CSI-MeasConfig ::= SEQUENCE {
  SL-CSI-RS-ResourceToAddModList A group of one or more SL-CSI-
RS-Resource
  SL-CSI-RS-ResourceToReleaseList A group of one or more SL-CSI-
RS-ResourceId
  SL-CSI-RS-ResourceSetToAddModList A group of one or more NZP-
CSI-RS-ResourceSet
  SL-CSI-RS-ResourceSetToReleaseList A group of one or more NZP-
CSI-RS-ResourceSetId
  Sl-csi-ResourceConfigToAddModList A group of one or more SL-CSI-
ResourceConfig
  Sl-csi-ResourceConfigToReleaseList A group of one or more SL-CSI-
ResourceConfigId
  Sl-csi-ReportConfigToAddModList A group of one or more SL-CSI-
ReportConfig
  Sl-csi-ReportConfigToReleaseList A group of one or more SL-CSI-
ReportConfigId
  reportTriggerSize INTEGER (0..6)
  aperiodicTriggerStateList SetupRelease { SL-CSI-
AperiodicTriggerStateList }
}
```

Referring to Table 5, the SL CSI measurement configuration may include CSI-RS resource information (e.g., SL-CSI-RS-Resource), CSI-RS resource set information (e.g., SL-CSI-RS-ResourceSet), CSI-RS resource configuration (e.g., SL-CSI-RS-ResourceConfig), SL CSI reporting configuration (e.g., SL-CSI-ReportConfig), and/or SL CSI aperiodic trigger state list (e.g., SL-CSI-AperiodicTriggerStateList). In addition, after configuration of CRI and time/frequency resources of the CSI-RS associated with each transmit beam, an SL CSI RS resource configuration ID (e.g., SL-CSI-RS-ResourceConfigID) may be configured in the SL CSI measurement configuration.

Table 6 shows an example of CSI-RS resource set information.

TABLE 6
SL-CSI-RS-ResourceSet-r16 ::= SEQUENCE {

| | |
|---|---|
| SL-CSI-RS-ResourceSetId | SL-CSI-RS-ResourceSetId, |
| SL-CSI-RS-Resources | A set of one or more SL-CSI-RS- |

Resource.

| | |
|---|---|
| repetition ENUMERATED | { on, off } for P3 procedure |
| aperiodicTriggeringOffset | A set of one or more slot offset |

INTEGER(0..6..[TBD])
(aperiodic only, X slots for the corresponding SL-CSI-RS-Resource,
indicating between n-th resource and n+1-th resource)
...
}

Table 7 shows an example of CSI-RS resource configuration.

TABLE 7
SL-CSI-RS-ResourceConfig-r16 ::= SEQUENCE {

| | |
|---|---|
| SL-CSI-RS-ResourceConfigId. | SL-CSI-RS- |
| | ResourceConfigId, |
| Sl-csi-RS-ResourceSetList | CHOICE { |
| SL-CSI-RS-SSB | SEQUENCE { |

```
      SL-CSI-RS-ResourceSetList SEQUENCE (SIZE (1..maxNrofNZP-
CSI-RS-ResourceSetsPerConfig)) OF SL-CSI-RS-ResourceSetId
      sl-csi-SSB-ResourceSetList SEQUENCE (SIZE (1..maxNrofCSI-
SSB-ResourceSetsPerConfig)) OF SL-CSI-SSB-ResourceSetId
    },
  },
  resourceType ENUMERATED { aperiodic, periodic },
...
}
```

Table 8 shows an example of SL CSI reporting configuration.

TABLE 8
SL-CSI-ReportConfig ::= SEQUENCE {

| | |
|---|---|
| reportConfigId | SL-CSI- |
| | ReportConfigId, |

resourcesForChannelMeasurement SL-CSI-ResourceConfigId, (refer
to ‘A group of one or more SL-CSI-RS-ResourceSet’ )

| | |
|---|---|
| reportConfigType | CHOICE { |
| periodic | SEQUENCE { |

```
        reportSlotConfig CSI-ReportPeriodicityAndOffset,
      },
```

| | |
|---|---|
| aperiodic | SEQUENCE { |

```
        reportSlotOffsetList SEQUENCE (SIZE (1..maxNrofUL-
Allocations)) OF INTEGER(0..32) (aperiodic only, Y slots)
      }
  }
  reportQuantity CHOICE {
```

| | |
|---|---|
| none | NULL, |
| RI-CQI | NULL, |
| cri-RI-CQI | NULL, |
| cri-RSRP | NULL, |
| ssb-Index-RSRP | NULL, |

}, ...,
groupBasedBeamReporting CHOICE {

| | |
|---|---|
| enabled | NULL, |
| disabled | SEQUENCE { |

```
        nrofReportedRS ENUMERATED {n1, n2, n3, n4}
        OPTIONAL -- Need S
      }
  },
  ...,
}
```

| | |
|---|---|
| CSI-ReportPeriodicityAndOffset ::= | CHOICE { |
| slots4 | INTEGER(0..3), |
| slots5 | INTEGER(0..4), |
| slots8 | INTEGER(0..7), |
| slots10 | INTEGER(0..9), |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}

Table 9 shows an example of SL CSI aperiodic trigger state list.

```
TABLE 9
SL-CSI-AperiodicTriggerStateList ::= SEQUENCE (SIZE
(1..maxNrOfSL-CSI-AperiodicTriggers)) OF SL-CSI-
AperiodicTriggerState
SL-CSI-AperiodicTriggerState ::= SEQUENCE {
  associatedReportConfigInfoList SEQUENCE
(SIZE(1..maxNrofReportConfigPerAperiodicTrigger)) OF SL-CSI-
AssociatedReportConfigInfo,
  ...
}
SL-CSI-AssociatedReportConfigInfo ::= SEQUENCE {
```

| | |
|---|---|
| reportConfigId | SL-CSI-ReportConfigId, |
| resourcesForChannel | CHOICE { |
| nzp-CSI-RS | SEQUENCE { |

```
      resourceSet INTEGER (1..maxNrofNZP-CSI-RS-
ResourceSetsPerConfig), (refer to Entry number of a group of one or
more SL-CSI-RS-ResourceSet indicated by SL-CSI-ResourceConfigId in
SL-CSI-ReportConfigId)
    },
    csi-SSB-ResourceSet INTEGER (1..maxNrofCSI-SSB-
ResourceSetsPerConfig)
  },
  ...
}
```

In step S1221, in response to the SL RRC reconfiguration message, the receiving UE may transmit an SL RRC reconfiguration complete message (e.g., RRCReconfigurationCompleteSidelink) to the transmitting UE.

In step S1230, the transmitting UE may transmit an SL CSI request via PSCCH to the receiving UE. For example, the SL CSI request may be an X-bit (e.g., 6-bit) indicator within the SCI transmitted via the PSCCH. Further, the transmitting UE may transmit a CSI-RS via PSSCH to the receiving UE. The SL CSI request may correspond to the CRI of the corresponding CSI-RS. Further, the SL CSI request may correspond to the beam on which the corresponding CSI-RS is transmitted.

In step S1231, the receiving UE may transmit the SL CSI reporting via PSSCH to the transmitting UE. For example, the receiving UE may measure the received CSI-RS to derive a CQI and/or RI, and may generate an SL CSI reporting MAC CE including the derived CQI and/or RI for reporting to the transmitting UE. For example, the SL CSI reporting may be transmitted aperiodically.

The SL CSI reporting may be transmitted within a period of time after the CSI request is received in step S1230. For example, the SL CSI latency bound (e.g., sl-LatencyBoundCSI-Report) may be configured via the SL RRC reconfiguration message received in step S1220, which may have a value of any one of 3 to 160 slots. The receiving UE may, after receiving the CSI request, transmit an SL CSI reporting to the transmitting UE within the SL CSI latency boundary.

In step S1240, the transmitting UE may transmit the SL CSI request via PSCCH to the receiving UE. For example, the SL CSI request may be an X-bit (e.g., 6-bit) indicator within the SCI transmitted via PSCCH. Further, the transmitting UE may transmit a CSI-RS via PSSCH to the receiving UE. The SL CSI request may correspond to the CRI of the corresponding CSI-RS. Further, the SL CSI request may correspond to the beam on which the corresponding CSI-RS is transmitted.

In step S1241, the receiving UE may transmit an SL CSI reporting via PSSCH to the transmitting UE. For example, the receiving UE may measure the received CSI-RS to derive a CQI and/or RI, and may generate an SL CSI reporting MAC CE including the derived CQI and/or RI for reporting to the transmitting UE. For example, the SL CSI reporting may be transmitted aperiodically.

The SL CSI reporting may be transmitted within a period of time after the CSI request is received in step S1240. For example, the SL CSI latency bound (e.g., sl-LatencyBoundCSI-Report) may be configured via the SL RRC reconfiguration message received in step S1220, which may have a value of any one of 3 to 160 slots. The receiving UE may, after receiving the CSI request, transmit the SL CSI reporting to the transmitting UE within the SL CSI latency boundary.

In FIG. 12, it is assumed that step S1240 is performed prior to step S1231.

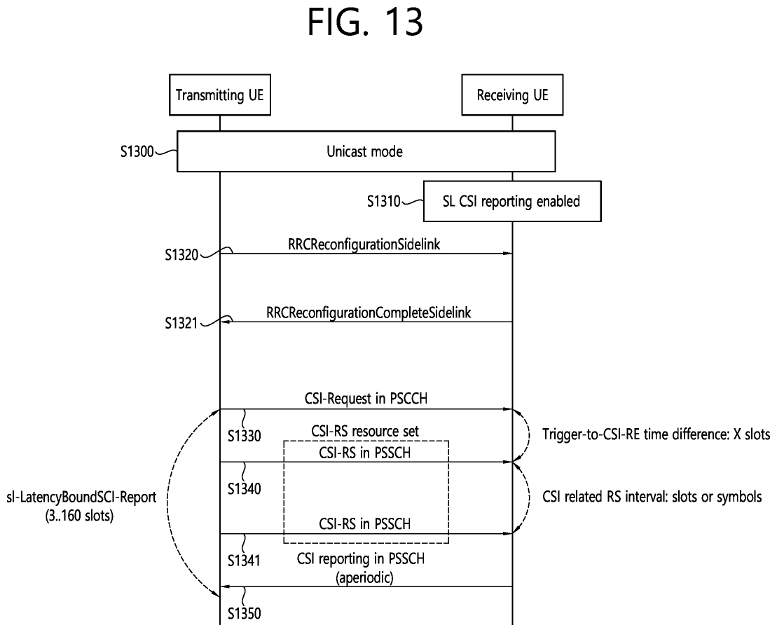

FIG. 13 shows another example of an SL CSI reporting method to which the first implementation of the present disclosure is applied.

In the operation of FIG. 13 for SL CSI reporting for a plurality of beams, the transmitting UE may transmit SCI including the SL CSI request field via PSCCH to the receiving UE, and may transmit a CSI-RS via a particular beam after a period of time (e.g., after X slots). Thereafter, the transmitting UE may transmit SCI including the SL CSI request field via PSCCH to the receiving UE and perform SL CSI reporting for the corresponding CSI-RS after a period of time (e.g., after the Y slot). This reduces the overhead of forwarding the SL CSI request for each CSI-RS transmission.

In this case, the SL CSI request field may indicate a resource set associated with a subsequent CSI-RS transmission, instead of indicating the presence or absence of SL CSI reporting via a single bit. That is, the SL CSI request field may function as a resource set selection via multiple bits rather than a single bit. Therefore, the size of the SL CSI request field may be larger than 1 bit (e.g., 6 bits), which may follow the aperiodic trigger state selection approach of UL CSI reporting.

If CSI-RSs are transmitted via up to 2-3 beams and SL CSI requests are transmitted for them, the SCI including the SL CSI request field may dynamically allocate different time resources to each CSI-RS. In this case, the size of the SL CSI request field may be 1 bit, and the CRI corresponding to each CSI-RS may be indexed in the transmission order of the CSI-RS.

The operations of steps S1300 through S1321 may correspond and/or be the same as the operations of steps S1200 through S1221 described in FIG. 12, respectively.

In step S1330, the transmitting UE may transmit a SL CSI request via PSCCH to the receiving UE. For example, the SL CSI request may be an X-bit (e.g., 6-bit) indicator within the SCI transmitted via PSCCH. Further, the transmitting UE may transmit a CSI-RS via PSSCH to the receiving UE. The SL CSI request may correspond to the CRI of the corresponding CSI-RS. Further, the SL CSI request may correspond to the beam on which the CSI-RS is transmitted.

Further, the SCI including the SL CSI request may use a new SCI format. Further, the SCI including the SL CSI request may include an initial CSI-RS to be transmitted in step S1340, to be described later.

In step S1340, the transmitting UE transmits a CSI-RS to the receiving UE. The CSI-RS may be transmitted X slots after the SL CSI request is transmitted in step S1330.

In step S1341, the transmitting UE transmits a CSI-RS to the receiving UE. The CSI-RS may be transmitted after a certain interval (e.g., slot or symbol) after the CSI-RS is transmitted in S1340. The CSI-RS transmitted in step S1341 may be transmitted using a different transmission pool than the CSI-RS transmitted in step S1340.

In step S1350, the receiving UE may transmit the SL CSI reporting via PSSCH to the transmitting UE. For example, the receiving UE may measure the received CSI-RS to derive a CQI and/or RI, and may generate an SL CSI reporting MAC CE including the derived CQI and/or RI for reporting to the transmitting UE. For example, the SL CSI reporting may be transmitted aperiodically.

The SL CSI reporting may be transmitted within a period of time after the SL CSI request is received in step S1330. For example, an SL CSI latency bound (e.g., sl-LatencyBoundCSI-Report) may be configured via the SL RRC reconfiguration message received in step S1320, which may have a value of any one of 3 to 160 slots. The receiving UE may, after receiving the SL CSI request, transmit an SL CSI reporting to the transmitting UE within the SL CSI latency boundary.

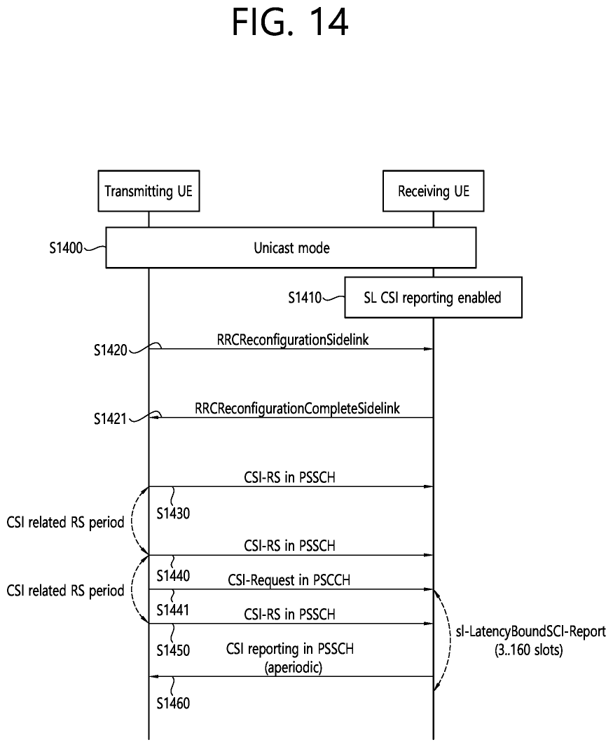

FIG. 14 shows another example of an SL CSI reporting method to which the first implementation of the present disclosure is applied.

In the operation of FIG. 14 for SL CSI reporting for a plurality of beams, a CSI-RS is periodically transmitted via PSSCH. The receiving UE continues to monitor the periodically received CSI-RS and may perform SL CSI reporting within a certain time period when the SL CSI request field is transmitted.

In this case, the SL CSI request field may indicate a resource set associated with a subsequent CSI-RS transmission, instead of indicating the presence or absence of SL CSI reporting via a single bit. That is, the SL CSI request field may function as a resource set selection via multiple bits rather than a single bit. Therefore, the size of the SL CSI request field may be larger than 1 bit (e.g., 6 bits), which may follow the aperiodic trigger state selection approach of UL CSI reporting.

Aperiodic CSI-RS transmission is good for obtaining UE-specific CSI, but it may limit the efficient operation of resources as the PSSCH has resources dedicated to CSI-RS. On the other hand, periodic CSI-RS transmissions may be more effective in resource utilization as CSI-RS may be transmitted together on the PSSCH for the self or other UEs.

The operations of steps S1400 through S1421 may correspond and/or be the same as the operations of steps S1200 through S1221 described in FIG. 12, respectively.

In step S1430, the transmitting UE transmits the CSI-RS to the receiving UE.

In step S1440, a certain number of cycles after transmitting the CSI-RS in step S1430, the transmitting UE transmits a CSI-RS to the receiving UE.

In step S1441, the transmitting UE may transmit a SL CSI request via PSCCH to the receiving UE. For example, the SL CSI request may be an X-bit (e.g., 6-bit) indicator in the SCI transmitted via PSCCH. Further, the transmitting UE may transmit a CSI-RS via PSSCH to the receiving UE. The SL CSI request may correspond to the CRI of the corresponding CSI-RS. Further, the SL CSI request may correspond to the beam on which the corresponding CSI-RS is transmitted.

In step S1450, a certain number of cycles after transmitting the CSI-RS in step S1440, the transmitting UE transmits the CSI-RS to the receiving UE.

In step S1460, the receiving UE may transmit an SL CSI reporting via PSSCH to the transmitting UE. For example, the receiving UE may measure the received CSI-RS to derive a CQI and/or RI, and may generate an SL CSI reporting MAC CE including the derived CQI and/or RI for reporting to the transmitting UE. For example, the SL CSI reporting may be transmitted aperiodically.

The SL CSI reporting may be transmitted within a period of time after the SL CSI request is received in step S1441. For example, an SL CSI latency bound (e.g., sl-LatencyBoundCSI-Report) may be configured via the SL RRC reconfiguration message received in step S1420, which may have a value of any one of 3 to 160 slots. The receiving UE may, after receiving the SL CSI request, transmit an SL CSI reporting to the transmitting UE within the SL CSI latency boundary.

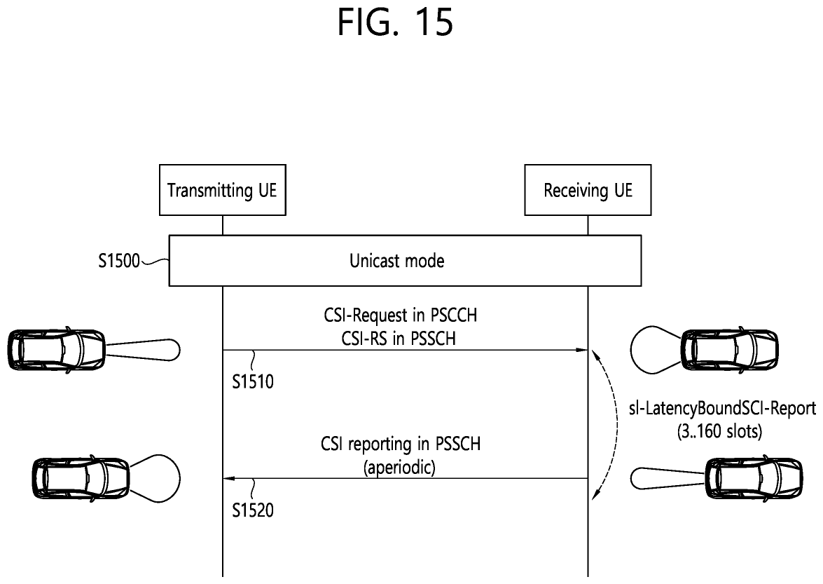

FIG. 15 shows another example of an SL CSI reporting method to which the first implementation of the present disclosure is applied.

In applying the first implementation of the present disclosure described above, it is assumed that directional beams are used. Through an initial beam search process, the transmit beam of the transmitting UE may be aligned with the receive beam of the receiving UE, and an SL CSI request may be transmitted based on the aligned beam. However, the SL CSI reporting may be transmitted after the SL CSI request is transmitted and after TX resource sensing within the SL CSI latency boundary, and as a result, it may be uncertain when the SL CSI reporting is transmitted to the transmitting UE. The receiving UE may shape the transmit beam to best match the direction of the receive beam based on channel reciprocity, but if the direction of the receive beam of the transmitting UE changes in the meantime, the SL CSI reporting may not be delivered properly.

Therefore, it is necessary to be able to predict when the SL CSI reporting is transmitted to the transmitting UE so that the transmitting UE can align its receive beam towards the receiving UE. To accomplish this, the beams of the transmitting UE and the receiving UE may be aligned with each other in the PSFCH cycles of the receiving pool from after the transmission of the SL CSI request up to the SL CSI latency boundary. Alternatively, based on a parameter (e.g., Period-to-Check) that is signaled to the upper layer, the beams of the transmitting UE and the beams of the receiving UE may be aligned with each other in slots corresponding to multiples of the corresponding parameter from after the transmission of the SL CSI request up to the SL CSI latency boundary.

In step S1500, the transmitting UE and the receiving UE may communicate in unicast mode. That is, the transmitting UE and the receiving UE may perform SL communication and/or V2X communication via a unicast connection.

In step S1510, the transmitting UE may transmit a CSI request via PSCCH to the receiving UE. Further, the transmitting UE may transmit a CSI-RS via PSSCH to the receiving UE. In this case, the transmit beam of the transmitting UE and the receive beam of the receiving UE may be aligned with each other.

The transmit beam of the transmitting UE and the receive beam of the receiving UE may be aligned with each other in the PSFCH cycle of the receiving pool from after the transmission of the SL CSI request up to the SL CSI latency boundary. Alternatively, based on a parameter (e.g., Period-to-Check) that is signaled to the upper layer, the beams of the transmitting UE and the beams of the receiving UE may be aligned with each other in slots corresponding to multiples of the corresponding parameter from after the transmission of the SL CSI request up to the SL CSI latency boundary.

In step S1520, the receiving UE may transmit the SL CSI reporting via PSSCH to the transmitting UE. For example, the receiving UE may measure the received CSI-RS to derive a CQI and/or RI, and generate an SL CSI reporting MAC CE including the derived CQI and/or RI for reporting to the transmitting UE. For example, the SL CSI reporting may be transmitted aperiodically.

The SL CSI reporting can be delivered accurately because the transmit beam of the receiving UE and the receive beam of the transmitting UE have been periodically aligned since receiving the CSI request.

The SL CSI reporting may be transmitted within a period of time after the CSI request is received in step S1510. For example, an SL CSI latency bound (e.g., sl-LatencyBoundCSI-Report) may be configured, which may have a value of any one of 3 to 160 slots. The receiving UE may, after receiving the CSI request, transmit the SL CSI reporting to the transmitting UE within the SL CSI latency boundary.

2. Second Implementation

A second implementation of the present disclosure provides a method for optimizing a bit size for measurement results of a plurality of CSI-RS resources included in an SL CSI reporting, in order to efficiently include measurement results of the plurality of CSI-RS resources in the SL CSI reporting.

In order to include measurement results of CSI-RS received via a plurality of beams in an SL CSI reporting, the second implementation of the present disclosure provides various methods for including information (e.g., CRI) for each beam in the SL CSI reporting. Further, the second implementations of the present disclosure provide various methods for including RSRP in the SL CSI reporting instead of conventional CQI and/or RI.

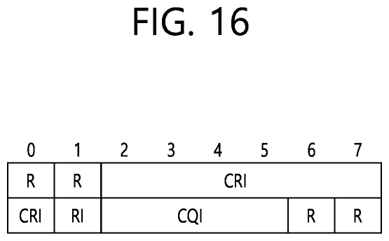

FIG. 16 shows an example of an SL CSI reporting MAC CE according to the second implementation of the present disclosure.

Referring to FIG. 16, the SL CSI reporting MAC CE includes information about the beam, i.e., a CRI. By default, the CRI may have a size of 7 bits. FIG. 16 contemplates expansion of the CRI, so that the CRI may be expanded to 9 bits by including 2 R bits.

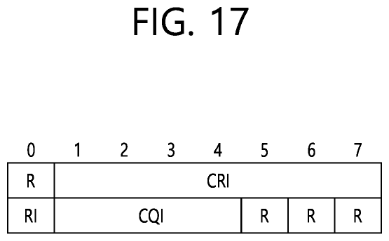

FIG. 17 shows another example of an SL CSI reporting MAC CE according to the second implementation of the present disclosure.

Referring to FIG. 17, the SL CSI reporting MAC CE includes information about the beam, i.e., the CRI. By default, the CRI may have a size of 7 bits. FIG. 17 contemplates an extension of the CRI, so that the CRI can be extended to 8 bits by including 1 bit of R bits.

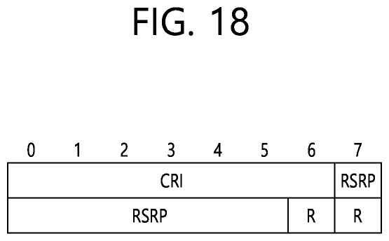

FIG. 18 shows another example of an SL CSI reporting MAC CE according to the second implementation of the present disclosure.

Referring to FIG. 18, the SL CSI reporting MAC CE includes a CRI and RSRP for one beam. In FIG. 18, it is assumed that the CRI has a size of 7 bits and the RSRP also has a size of 7 bits.

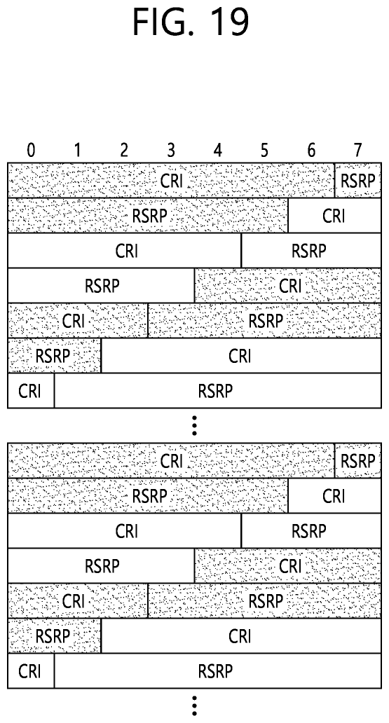

FIG. 19 shows another example of an SL CSI reporting MAC CE according to the second implementation of the present disclosure.

Referring to FIG. 19, the SL CSI reporting MAC CE includes a CRI and an RSRP for each of the plurality of beams. In FIG. 19, it is assumed that the CRI has a size of 7 bits and the RSRP also has a size of 7 bits. Table 10 shows an example of an RSRP measurement reporting mapping table associated with an RSRP of 7 bits.

TABLE 10

| | | Measured quantity | |
|---|---|---|---|
| Reported | Measured quantity value | value (L1 SS-RSRP | |
| value | (L3 SS-RSRP) | and CSI-RSRP) | Unit |
| RSRP_0 | SS-RSRP < −156 | Not valid | dBm |
| RSRP_1 | −156 ≤ SS-RSRP < −155 | Not valid | dBm |
| RSRP_2 | −155 ≤ SS-RSRP < −154 | Not valid | dBm |
| RSRP_3 | −154 ≤ SS-RSRP < −153 | Not valid | dBm |
| RSRP_4 | −153 ≤ SS-RSRP < −152 | Not valid | dBm |
| RSRP_5 | −152 ≤ SS-RSRP < −151 | Not valid | dBm |
| RSRP_6 | −151 ≤ SS-RSRP < −150 | Not valid | dBm |
| RSRP_7 | −150 ≤ SS-RSRP < −149 | Not valid | dBm |
| RSRP_8 | −149 ≤ SS-RSRP < −148 | Not valid | dBm |
| RSRP_9 | −148 ≤ SS-RSRP < −147 | Not valid | dBm |
| RSRP_10 | −147 ≤ SS-RSRP < −146 | Not valid | dBm |
| RSRP_11 | −146 ≤ SS-RSRP < −145 | Not valid | dBm |
| RSRP_12 | −145 ≤ SS-RSRP < −144 | Not valid | dBm |
| RSRP_13 | −144 ≤ SS-RSRP < −143 | Not valid | dBm |
| RSRP_14 | −143 ≤ SS-RSRP < −142 | Not valid | dBm |
| RSRP_15 | −142 ≤ SS-RSRP < −141 | Not valid | dBm |
| RSRP_16 | −141 ≤ SS-RSRP < −140 | RSRP < −140 | dBm |
| RSRP_17 | −140 ≤ SS-RSRP < −139 | −140 ≤ RSRP < −139 | dBm |
| RSRP_18 | −139 ≤ SS-RSRP < −138 | −139 ≤ RSRP < −138 | dBm |
| . . . | . . . | | . . . |
| RSRP_111 | −46 ≤ SS-RSRP < −45 | −46 ≤ RSRP < −45 | dBm |
| RSRP_112 | −45 ≤ SS-RSRP < −44 | −45 ≤ RSRP < −44 | dBm |
| RSRP_113 | −44 ≤ SS-RSRP < −43 | −44 ≤ RSRP | dBm |
| RSRP_114 | −43 ≤ SS-RSRP < −42 | Not valid | dBm |
| RSRP_115 | −42 ≤ SS-RSRP < −41 | Not valid | dBm |
| RSRP_116 | −41 ≤ SS-RSRP < −40 | Not valid | dBm |
| RSRP_117 | −40 ≤ SS-RSRP < −39 | Not valid | dBm |
| RSRP_118 | −39 ≤ SS-RSRP < −38 | Not valid | dBm |
| RSRP_119 | −38 ≤ SS-RSRP < −37 | Not valid | dBm |
| RSRP_120 | −37 ≤ SS-RSRP < −36 | Not valid | dBm |
| RSRP_121 | −36 ≤ SS-RSRP < −35 | Not valid | dBm |
| RSRP_122 | −35 ≤ SS-RSRP < −34 | Not valid | dBm |
| RSRP_123 | −34 ≤ SS-RSRP < −33 | Not valid | dBm |
| RSRP_124 | −33 ≤ SS-RSRP < −32 | Not valid | dBm |
| RSRP_125 | −32 ≤ SS-RSRP < −31 | Not valid | dBm |
| RSRP_126 | −31 ≤ SS-RSRP | Not valid | dBm |
| RSRP_127 | Infinity | Infinity | dBm |

In FIG. 19, as the number of beams increases, the CRI and RSRP for each beam are also included in the SL CSI reporting MAC CE, which can increase the size of the SL CSI reporting MAC CE. This may increase the overhead of SL CSI reporting.

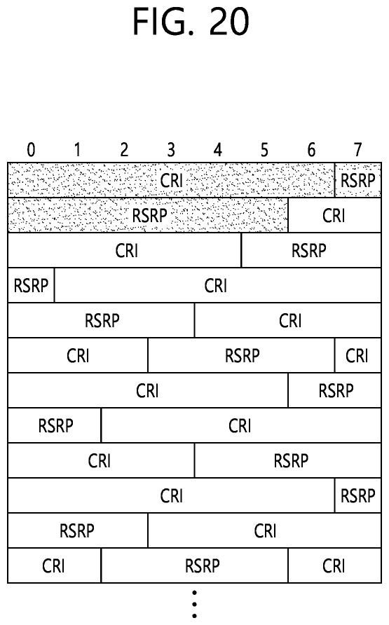

FIG. 20 shows another example of an SL CSI reporting MAC CE according to the second implementation of the present disclosure.

Referring to FIG. 20, the SL CSI reporting MAC CE includes a CRI and an RSRP for each of the plurality of beams. In FIG. 20, it is assumed that the CRI has a size of 7 bits and the RSRP has a size of 4 bits. Table 11 shows an example of an RSRP measurement reporting mapping table associated with an RSRP of 4 bits.

TABLE 11

| | Measured quantity value (difference in | |
|---|---|---|
| Reported value | measured RSRP from strongest RSRP) | Unit |
| DIFFRSRP_0 | 0 ≥ ΔRSRP > −2 | dB |
| DIFFRSRP_1 | −2 ≥ ΔRSRP > −4 | dB |
| DIFFRSRP_2 | −4 ≥ ΔRSRP > −6 | dB |
| DIFFRSRP_3 | −6 ≥ ΔRSRP > −8 | dB |
| DIFFRSRP_4 | −8 ≥ ΔRSRP > −10 | dB |
| DIFFRSRP_5 | −10 ≥ ΔRSRP > −12 | dB |
| DIFFRSRP_6 | −12 ≥ ΔRSRP > −14 | dB |
| DIFFRSRP_7 | −14 ≥ ΔRSRP > −16 | dB |
| DIFFRSRP_8 | −16 ≥ ΔRSRP > −18 | dB |
| DIFFRSRP_9 | −18 ≥ ΔRSRP > −20 | dB |
| DIFFRSRP_10 | −20 ≥ ΔRSRP > −22 | dB |
| DIFFRSRP_11 | −22 ≥ ΔRSRP > −24 | dB |
| DIFFRSRP_12 | −24 ≥ ΔRSRP > −26 | dB |
| DIFFRSRP_13 | −26 ≥ ΔRSRP > −28 | dB |
| DIFFRSRP_14 | −28 ≥ ΔRSRP > −30 | dB |
| DIFFRSRP_15 | −30 ≥ ΔRSRP | dB |

That is, instead of using the 7-bit RSRP associated with Table 10, the RSRP in FIG. 20 uses the 4-bit DIFFRSRP associated with Table 11. This can reduce the overhead of SL CSI reporting.

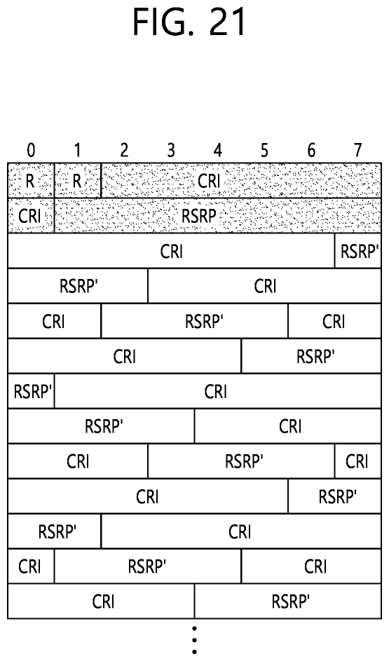

FIG. 21 shows another example of an SL CSI reporting MAC CE according to the second implementation of the present disclosure.

Referring to FIG. 21, the SL CSI reporting MAC CE includes a CRI and an RSRP for each of the plurality of beams. In FIG. 21, it is assumed that the CRI has a size of 7 bits and the RSRP has a size of 4 bits, which means that the DIFFRSRP described in Table 11 may be used. Also, the 7-bit CRI may be extended to 9 bits.

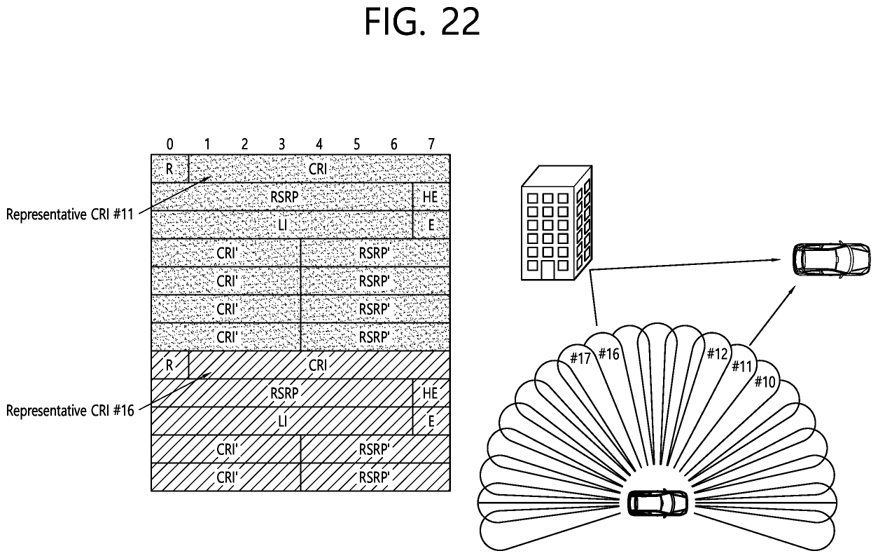

FIG. 22 shows another example of an SL CSI reporting MAC CE according to the second implementation of the present disclosure.

In FIG. 22, it may be assumed that the strongest beam of the beams reaching the receiving UE and the beams around it are primarily clustered. By default, assuming that the CRI has a size of 7 bits, the CRI for the strongest beam is included in the SL CSI reporting using 7 bits, while the CRI for the beams around it may be included in the SL CSI reporting with a CRI offset value of 4 bits. Table 12 shows an example of CRI offset values and their corresponding offsets.

TABLE 12

| Value | Offset |
|---|---|
| 0 | −8 |
| 1 | −7 |
| 2 | −6 |
| 3 | −5 |
| 4 | −4 |
| 5 | −3 |
| 6 | −2 |
| 7 | −1 |
| 8 | 1 |
| 9 | 2 |
| 10 | 3 |
| 11 | 4 |
| 12 | 5 |
| 13 | 6 |
| 14 | 7 |
| 15 | 8 |

Referring to Table 12, based on the CRI offset value, the CRI of the neighboring beams may be expressed relative to the representative CRI. For example, in FIG. 22, beam #11 and beam #16, which are the beams with the largest RSRP, may correspond to the representative CRI. Relative to beam #11 and beam #16 corresponding to the representative CRI, the neighboring beams #12 and beam #17 may be represented by a CRI offset value of 8 (i.e., a corresponding offset of 1). Further, relative to beam #11 and beam #16 corresponding to the representative CRI, the neighboring beam #10 may be represented by a CRI offset value of 7 (i.e., corresponding offset −11).

In general, neighboring beams around the beam corresponding to the representative CRI may be measured. In addition, some beams may have a high RSRP due to multipath effects, even if they are not the neighboring beams corresponding to the representative CRI, and they may also be measured in clusters.

In FIG. 22, additional fields included in the SL CSI reporting MAC CE are as follows
Header Extension (HE): Indicates the presence of the following LI header if the CRI is greater than one.
Length Indicator (LI): Indicates the number of CRI offsets that are dependent on the representative CRI.
Extension (E): Indicates the presence or absence of the following representative CRI.

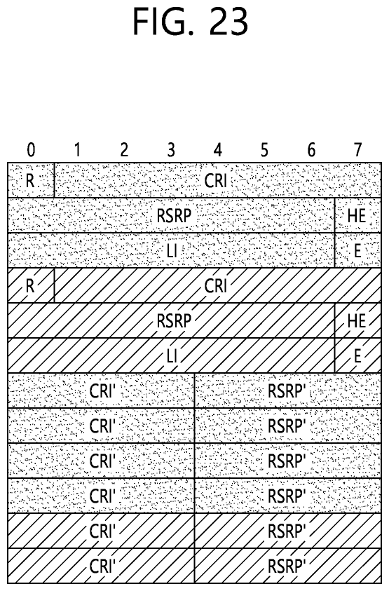

FIG. 23 shows another example of an SL CSI reporting MAC CE according to the second implementation of the present disclosure.

FIG. 23 shows the SL CSI reporting MAC CE shown in FIG. 22 with the representative CRI and header information moved to the front for improved readability.

The present disclosure can have various advantageous effects.

For example, after the initial beam alignment (e.g., beam search) of the bidirectional transmit beamforming of UEs participating in the communication for V2X services has been completed, the necessary SL CSI reporting can be performed during the beam refinement process.

For example, SL CSI reporting can be performed in consideration of the operation of the directional beams.

For example, the overhead of SL CSI reporting by a plurality of beams can be reduced.

For example, SL communications and/or V2X communications can be performed efficiently in the mmWave band.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a receiving User Equipment (UE) in a wireless communication system, the method comprising:
establishing a unicast link with a transmitting UE;
receiving a Sidelink (SL) Radio Resource Control (RRC) reconfiguration message from the transmitting UE, wherein the SL RRC reconfiguration message comprises a configuration for a Channel State Information Reference Signal (CSI-RS);
transmitting an SL RRC reconfiguration complete message to the transmitting UE in response to the SL RRC reconfiguration message;
receiving a first SL control information from the transmitting UE, wherein the first SL control information comprises a first CSI-RS Resource Index (CRI) indicating a CSI request for a first beam;
receiving a second SL control information from the transmitting UE, wherein the second SL control information comprises a second CRI indicating a CSI request for a second beam;
receiving the CSI-RS from the transmitting UE via the first beam and the second beam;
measuring the CSI-RS received via the first beam and the second beam; and
transmitting an SL CSI reporting to the transmitting UE, wherein the SL CSI reporting comprises a result of the measurement, the first CRI and the second CRI.

2. The method of claim 1, wherein the first CRI included in the first SL control information and/or the second CRI included in the second SL control information has a size greater than one bit.

3. The method of claim 2, wherein, after the first SL control information is received, the CSI-RS is received via the first beam after X slot, and
wherein, after the first SL control information is received, the SL CSI reporting is transmitted after Y slot.

4. The method of claim 2, wherein the CSI-RS received via the first beam and the CSI-RS received via the second beam are received at regular periods.

5. The method of claim 1, wherein the SL CSI reporting is transmitted within an SL CSI latency boundary configured in the SL RRC reconfiguration message from after the first SL control information is received.

6. The method of claim 1, wherein the first CRI included in the first SL control information and/or the second CRI included in the second SL control information has a size of 1 bit, and
wherein the CSI-RS received via the first beam and the CSI-RS received via the second beam are received via different dynamically allocated time resources.

7. The method of claim 1, wherein the first beam and a beam of the transmitting UE are aligned with each other in a Physical Sidelink Feedback Channel (PSFCH) cycle of a receiving pool, within an SL CSI latency boundary configured in the SL RRC reconfiguration message from after the first SL control information is received.

8. The method of claim 1, wherein the first beam and a beam of the transmitting UE are aligned with each other in a slot corresponding to a multiple of a beam alignment cycle check parameter received by an upper layer, within an SL CSI latency boundary configured in the SL RRC reconfiguration message from after the first SL control information is received.

9. The method of claim 1, wherein the SL RRC reconfiguration message comprises a configuration to enable the SL CSI reporting to include a CRI and a Reference Signal Received Power (RSRP).

10. The method of claim 9, wherein the first CRI and/or the second CRI included in the SL CSI reporting has a size of at least 7 bits.

11. The method of claim 9, wherein the result of the measurement included in the SL CSI reporting comprises an RSRP of the CSI-RS received via the first beam and an RSRP of the CSI-RS received via the second beam,
wherein the RSRP of the CSI-RS received via the first beam has a size of 7 bits, and
wherein the RSRP of the CSI-RS received via the second beam has a size of 4 bits.

12. The method of claim 9, wherein the first CRI and/or the second CRI included in the SL CSI reporting is expressed as an offset value of 4 bits relative to a representative CRI.

13. The method of claim 1, wherein the receiving UE is in communication with at least one of a mobile device, a network, and/or autonomous vehicles other than the receiving UE.

14. A receiving User Equipment (UE) operating in a wireless communication system, the receiving UE comprising:
at least one transceiver,
at least one processor, and
at least one memory operably connectable to the at least one processor and storing instructions that, based on being executed by the at least one processor, perform operations comprising:
establishing a unicast link with a transmitting UE;
receiving, via the at least one transceiver, a Sidelink (SL) Radio Resource Control (RRC) reconfiguration message from the transmitting UE, wherein the SL RRC reconfiguration message comprises a configuration for a Channel State Information Reference Signal (CSI-RS);
transmitting, via the at least one transceiver, an SL RRC reconfiguration complete message to the transmitting UE in response to the SL RRC reconfiguration message;
receiving, via the at least one transceiver, a first SL control information from the transmitting UE, wherein the first SL control information comprises a first CSI-RS Resource Index (CRI) indicating a CSI request for a first beam;
receiving, via the at least one transceiver, a second SL control information from the transmitting UE, wherein the second SL control information comprises a second CRI indicating a CSI request for a second beam;
receiving, via the at least one transceiver, the CSI-RS from the transmitting UE via the first beam and the second beam;
measuring the CSI-RS received via the first beam and the second beam; and
transmitting, via the at least one transceiver, an SL CSI reporting to the transmitting UE, wherein the SL CSI reporting comprises a result of the measurement, the first CRI and the second CRI.

15.-17. (canceled)

18. A transmitting User Equipment (UE) operating in a wireless communication system, the transmitting UE comprising:
at least one transceiver,
at least one processor, and
at least one memory operably connectable to the at least one processor and storing instructions that, based on being executed by the at least one processor, perform operations comprising:
establishing a unicast link with a receiving UE;
transmitting, via the at least one transceiver, a Sidelink (SL) Radio Resource Control (RRC) reconfiguration message to the receiving UE, wherein the SL RRC reconfiguration message comprises a configuration for a Channel State Information Reference Signal (CSI-RS);
receiving, via the at least one transceiver, an SL RRC reconfiguration complete message from the receiving UE in response to the SL RRC reconfiguration message;
transmitting, via the at least one transceiver, a first SL control information to the receiving UE, wherein the first SL control information comprises a first CSI-RS Resource Index (CRI) indicating a CSI request for a first beam;
transmitting, via the at least one transceiver, a second SL control information to the receiving UE, wherein the second SL control information comprises a second CRI indicating a CSI request for a second beam;
transmitting, via the at least one transceiver, the CSI-RS to the receiving UE via the first beam and the second beam; and
receiving, via the at least one transceiver, an SL CSI reporting from the receiving UE, wherein the SL CSI reporting comprises a result of measurement on the CSI-RS, the first CRI and the second CRI.

19-20. (canceled)
